(19) United States
(12) Patent Application Publication
(10) Pub. No.: US 2026/0202585 A1
(43) Pub. Date: Jul. 16, 2026

(54) Anti-Reflection Coated Lens for Fast Axis Collimation

(71) Applicant: Waymo LLC, Mountain View, CA (US)

(72) Inventors: Thanh Tu, San Jose, CA (US); Yeh-Jiun Tung, Sunnyvale, CA (US); James Dunphy, San Jose, CA (US); Hongqin Shi, San Jose, CA (US)

(21) Appl. No.: 19/565,823

(22) Filed: Mar. 13, 2026

Related U.S. Application Data
(63) Continuation of application No. 18/062,085, filed on Dec. 6, 2022.

(51) Int. Cl. G02B 1/11; G01S 13/89; G01S 17/89; G02B 27/02; G02B 27/30

(52) U.S. Cl. CPC G02B 1/11; G01S 13/89; G01S 17/89; G02B 27/024; G02B 27/30

(57) ABSTRACT

An optical system comprises a light emitter, an optical waveguide, and a lens that optically couples the light emitter to the optical waveguide. The lens has a long axis and a plurality of surfaces surrounding the long axis, the plurality of surfaces including a convex surface and a flat surface. The convex surface faces the light emitter such that light emitted by the light emitter enters the lens through the convex surface. In some examples, the lens serves as a fast axis collimation (FAC) lens. In some examples, the flat surface serves as a mounting surface to mount the lens on a substrate such that the convex surface faces the light emitter and an output surface of the lens opposite the convex surface faces the optical waveguide. In some examples, the convex surface includes an anti-reflection coating.

### CROSS-REFERENCE TO RELATED APPLICATIONS

This application is a continuation of U.S. patent application Ser. No. 18/062,085, filed Dec. 6, 2022, which is incorporated herein by reference.

### BACKGROUND

Unless otherwise indicated herein, the description in this section is not prior art to the claims in this application and is not admitted to be prior art by inclusion in this section.

A laser diode may emit light that diverges differently in two orthogonal directions. For example, a typical laser diode may emit light that has a relatively small divergence (e.g., a 10 degree divergence) in one direction, often called the “slow” axis, and a much high higher divergence (e.g., a 30 degree divergence) in the orthogonal direction, often called the “fast” axis. In many applications, it is desirable to use a lens that collimates the light emitted from a laser diode along the fast axis. Such a lens may be described as a fast axis collimation (FAC) lens.

### SUMMARY

Disclosed herein are optical systems in which a lens optically couples a light emitter to an optical waveguide and methods for fabricating such optical systems. The lens can have a modified cylindrical shape with a long axis and a plurality of surfaces surrounding the long axis. The plurality of surfaces can include a convex input surface, an output surface (which could be flat, convex, or have some other shape), and a flat mounting surface between the convex input surface and the output surface. The flat mounting surface can be used to mount the lens on a substrate such that the convex input surface faces the light emitter and the output surface faces the optical waveguide. With this arrangement, light emitted by the light emitter enters the lens through the convex input surface and exits the lens through the output surface. The convex input surface may have an anti-reflection coating to reduce reflections of the emitted light off the convex input surface. The output surface may also have an anti-reflection coating to reduce reflections. In some embodiments, the output surface of the lens is bonded to the optical waveguide by an optical coupling adhesive. In some embodiments, the light emitter is a laser diode. In such embodiments, the lens may serve as a FAC lens that at least partially collimates the emitted light along the fast axis of the laser diode.

In a first aspect, an optical system is provided. The optical system includes a light emitter, an optical waveguide, and a lens that optically couples the light emitter to the optical waveguide. The lens has a long axis and a plurality of surfaces surrounding the long axis, the plurality of surfaces including a convex surface and a flat surface. The convex surface faces the light emitter such that light emitted by the light emitter enters the lens through the convex surface.

In a second aspect, a method is provided. The method involves optically coupling a lens to an optical waveguide. The lens has a long axis and a plurality of surfaces surrounding the long axis, the plurality of surfaces including a convex input surface, an output surface, and a flat mounting surface between the convex input surface and the output surface. The optical waveguide is mounted on a substrate, and optically coupling the lens to the optical waveguide involves mounting the flat mounting surface on the substrate such that the output surface faces the optical waveguide. The method further involves optically coupling a light emitter to the lens, such that light emitted by the light emitter enters the lens through the convex input surface.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1 is a functional block diagram illustrating a vehicle, according to example embodiments.

FIG. 2A is an illustration of a physical configuration of a vehicle, according to example embodiments.

FIG. 2B is an illustration of a physical configuration of a vehicle, according to example embodiments.

FIG. 2C is an illustration of a physical configuration of a vehicle, according to example embodiments.

FIG. 2D is an illustration of a physical configuration of a vehicle, according to example embodiments.

FIG. 2E is an illustration of a physical configuration of a vehicle, according to example embodiments.

FIG. 2F is an illustration of a physical configuration of a vehicle, according to example embodiments.

FIG. 2G is an illustration of a physical configuration of a vehicle, according to example embodiments.

FIG. 2H is an illustration of a physical configuration of a vehicle, according to example embodiments.

FIG. 2I is an illustration of a physical configuration of a vehicle, according to example embodiments.

FIG. 2J is an illustration of a field of view for various sensors, according to example embodiments.

FIG. 2K is an illustration of beam steering for a sensor, according to example embodiments.

FIG. 3 is a conceptual illustration of wireless communication between various computing systems related to an autonomous or semi-autonomous vehicle, according to example embodiments.

FIG. 4A is a block diagram of a system including a lidar device, according to example embodiments.

FIG. 4B is a block diagram of a lidar device, according to example embodiments.

FIG. 5 illustrates a sectional view of a lidar device, according to example embodiments.

FIG. 6 illustrates an optical system, according to example embodiments.

FIG. 7A illustrates a cross section of a lens, according to example embodiments.

FIG. 7B illustrates a cross section of a lens, according to example embodiments.

FIG. 7C illustrates a cross section of a lens, according to example embodiments.

FIG. 8 illustrates an optical system, according to example embodiments.

FIG. 9 illustrates an optical system, according to example embodiments.

FIG. 10 illustrates an optical system, according to example embodiments.

FIG. 11 is a flowchart diagram illustrating a method, according to example embodiments.

### DETAILED DESCRIPTION

Example methods and systems are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are contemplated herein. In addition, the particular arrangements shown in the figures should not be viewed as limiting. It should be understood that other embodiments might include more or less of each element shown in a given figure. Additionally, some of the illustrated elements may be combined or omitted. Yet further, an example embodiment may include elements that are not illustrated in the figures.

Lidar devices as described herein can include one or more light emitters and one or more detectors used for detecting light that is emitted by the one or more light emitters and reflected by one or more objects in an environment surrounding the lidar device. As an example, the surrounding environment could include an interior or exterior environment, such as an inside of a building or an outside of a building. Additionally or alternatively, the surrounding environment could include an interior of a vehicle. Still further, the surrounding environment could include a vicinity around and/or on a roadway. Examples of objects in the surrounding environment include, but are not limited to, other vehicles, traffic signs, pedestrians, bicyclists, roadway surfaces, buildings, and terrain. Additionally, the one or more light emitters could emit light into a local environment of the lidar itself. For example, light emitted from the one or more light emitters could interact with a housing of the lidar and/or surfaces or structures coupled to the lidar. In some cases, the lidar could be mounted to a vehicle, in which case the one or more light emitters could be configured to emit light that interacts with objects within a vicinity of the vehicle. Further, the light emitters could include optical fiber amplifiers, laser diodes, light-emitting diodes (LEDs), among other possibilities.

In some implementations, a laser diode may be used with a FAC lens in a light detection and ranging (lidar) device. For example, a laser diode may be optically coupled to an optical waveguide via a FAC lens. In this configuration, the FAC lens collimates the light emitted by the laser diode along the fast axis (e.g., without collimating the emitted light along the slow axis) to provide fast-axis collimated light that is then coupled into an input section of the optical waveguide. The optical waveguide may guide the light from the input section to an output section where the light is coupled out of the waveguide. The lidar device may include an optical system (e.g., one or more lenses) that fully collimates the outcoupled light and transmits the fully collimated light toward a scene.

In example embodiments, the FAC lens used to couple light into the optical waveguide is a plano-convex cylindrical lens. The plano-convex cylindrical lens can have a long axis surrounded by a convex surface and three flat surfaces to provide a D-shaped cross section. The convex surface can serve as an input surface of the FAC lens. One of the flat surfaces can be directly opposite the convex surface and serve as an output surface. Thus, light from the laser diode may enter the lens through the convex surface and exit the lens through the flat output surface. The other two flat surfaces can be on either side of and generally perpendicular to the flat output surface.

The plano-convex lens can be arranged between the laser diode and the optical waveguide with the convex surface facing the laser diode but spaced apart from the laser diode by an air gap. An anti-reflection (AR) coating can be applied to the convex surface. The AR coating could be applied using evaporation, sputtering, or some other technique. The AR coating can reduce light losses due to unwanted reflections and can also reduce or eliminate instabilities caused by light that is reflected back into the laser diode. The flat output surface could be attached to an input end of the optical waveguide, for example, using an optical coupling adhesive (OCA). The OCA can beneficially reduce light reflected at the two surfaces without an AR coating. Alternatively, the flat surface opposite the convex surface could be spaced apart from the input section of the optical waveguide by an air gap. In that case, it can be beneficial to apply an AR coating to the flat output surface.

In addition to a D-shaped cross section, other shapes are possible as well. For example, the FAC lens could have two convex surfaces on opposite sides of each other (with one convex surface serving as the input surface and the other convex surface serving as the output surface) and either one or two flat surfaces between the two convex surfaces.

In example embodiments, the FAC lens has at least one flat surface, so that the FAC lens can be mounted on a flat substrate with the convex surface facing the laser diode and the output surface facing the optical waveguide. For example, both the optical waveguide and the FAC lens can be disposed on a glass substrate. The optical waveguide can be formed by photolithographically patterning a photoresist material on the glass substrate. Then, a flat surface of the FAC lens can be bonded to the glass substrate, for example, using a UV-curable adhesive. The flat surface of the FAC lens can also provide an orientation for applying the AR coating to the FAC lens (e.g., when applying the AR coating to the convex surface of the FAC lens).

In some examples, one FAC lens can optically couple a plurality of laser diodes to a plurality of optical waveguides. For example, a plurality of laser diodes can be arranged on one side of the FAC lens and a plurality of optical waveguides can be arranged on the opposite side of the FAC lens.

The following description and accompanying drawings will elucidate features of various example embodiments. The embodiments provided are by way of example, and are not intended to be limiting. As such, the dimensions of the drawings are not necessarily to scale.

Example systems within the scope of the present disclosure will now be described in greater detail. An example system may be implemented in or may take the form of an automobile. Additionally, an example system may also be implemented in or take the form of various vehicles, such as cars, trucks (e.g., pickup trucks, vans, tractors, and tractor trailers), motorcycles, buses, airplanes, helicopters, drones, lawn mowers, earth movers, boats, submarines, all-terrain vehicles, snowmobiles, aircraft, recreational vehicles, amusement park vehicles, farm equipment or vehicles, construction equipment or vehicles, warehouse equipment or vehicles, factory equipment or vehicles, trams, golf carts, trains, trolleys, sidewalk delivery vehicles, and robot devices. Other vehicles are possible as well. Further, in some embodiments, example systems might not include a vehicle.

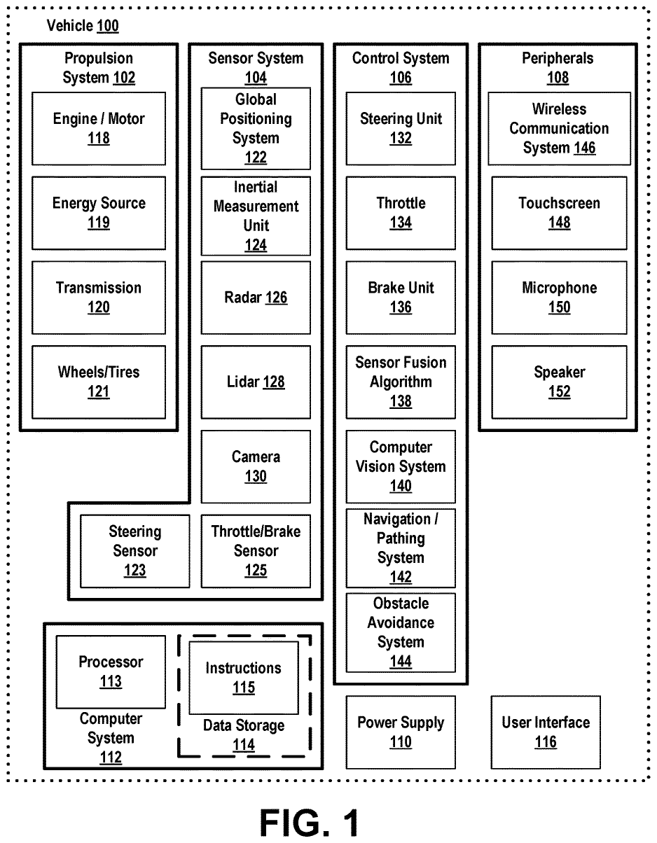

Referring now to the figures, FIG. 1 is a functional block diagram illustrating example vehicle 100, which may be configured to operate fully or partially in an autonomous mode. More specifically, vehicle 100 may operate in an autonomous mode without human interaction through receiving control instructions from a computing system. As part of operating in the autonomous mode, vehicle 100 may use sensors to detect and possibly identify objects of the surrounding environment to enable safe navigation. Additionally, example vehicle 100 may operate in a partially autonomous (i.e., semi-autonomous) mode in which some functions of the vehicle 100 are controlled by a human driver of the vehicle 100 and some functions of the vehicle 100 are controlled by the computing system. For example, vehicle 100 may also include subsystems that enable the driver to control operations of vehicle 100 such as steering, acceleration, and braking, while the computing system performs assistive functions such as lane-departure warnings/lane-keeping assist or adaptive cruise control based on other objects (e.g., vehicles) in the surrounding environment.

As described herein, in a partially autonomous driving mode, even though the vehicle assists with one or more driving operations (e.g., steering, braking and/or accelerating to perform lane centering, adaptive cruise control, advanced driver assistance systems (ADAS), and emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods are described below in conjunction with autonomous vehicles, these or similar systems and methods can be used in various driver assistance systems that do not rise to the level of fully autonomous driving systems (i.e. partially autonomous driving systems). In the United States, the Society of Automotive Engineers (SAE) have defined different levels of automated driving operations to indicate how much, or how little, a vehicle controls the driving, although different organizations, in the United States or in other countries, may categorize the levels differently. More specifically, the disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway) conditions. Likewise, the disclosed systems and methods can be used in vehicles that use SAE Level 4 self-driving systems that operate autonomously under most regular driving situations and require only occasional attention of the human operator. In all such systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations'levels of automated driving operations.

As shown in FIG. 1, vehicle 100 may include various subsystems, such as propulsion system 102, sensor system 104, control system 106, one or more peripherals 108, power supply 110, computer system 112 (which could also be referred to as a computing system) with data storage 114, and user interface 116. In other examples, vehicle 100 may include more or fewer subsystems, which can each include multiple elements. The subsystems and components of vehicle 100 may be interconnected in various ways. In addition, functions of vehicle 100 described herein can be divided into additional functional or physical components, or combined into fewer functional or physical components within embodiments. For instance, the control system 106 and the computer system 112 may be combined into a single system that operates the vehicle 100 in accordance with various operations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, an electric motor, steam engine, or Stirling engine, among other possible options. For instance, in some embodiments, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118). For instance, energy source 119 can correspond to gasoline, diesel, other petroleum-based fuels, propane, other compressed gas-based fuels, ethanol, solar panels, batteries, and/or other sources of electrical power. In some embodiments, energy source 119 may include a combination of fuel tanks, batteries, capacitors, and/or flywheels.

Transmission 120 may transmit mechanical power from engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example embodiments. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, radar 126, lidar 128, camera 130, steering sensor 123, and throttle/brake sensor 125, among other possible sensors. In some embodiments, sensor system 104 may also include sensors configured to monitor internal systems of the vehicle 100 (e.g., O₂ monitor, fuel gauge, engine oil temperature, and brake wear).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar 126 may represent one or more systems configured to use radio signals to sense objects, including the speed and heading of the objects, within the surrounding environment of vehicle 100. As such, radar 126 may include antennas configured to transmit and receive radio signals. In some embodiments, radar 126 may correspond to a mountable radar configured to obtain measurements of the surrounding environment of vehicle 100.

Lidar 128 may include one or more laser sources, a laser scanner, and one or more detectors, among other system components, and may operate in a coherent mode (e.g., using heterodyne detection) or in an incoherent detection mode (i.e., time-of-flight mode). In some embodiments, the one or more detectors of the lidar 128 may include one or more photodetectors, which may be especially sensitive detectors (e.g., avalanche photodiodes). In some examples, such photodetectors may be capable of detecting single photons (e.g., single-photon avalanche diodes (SPADs)). Further, such photodetectors can be arranged (e.g., through an electrical connection in series) into an array (e.g., as in a silicon photomultiplier (SiPM)). In some examples, the one or more photodetectors are Geiger-mode operated devices and the lidar includes subcomponents designed for such Geiger-mode operation.

Camera 130 may include one or more devices (e.g., still camera, video camera, a thermal imaging camera, a stereo camera, and a night vision camera) configured to capture images of the surrounding environment of vehicle 100.

Steering sensor 123 may sense a steering angle of vehicle 100, which may involve measuring an angle of the steering wheel or measuring an electrical signal representative of the angle of the steering wheel. In some embodiments, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, an angle of a gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve or a carburetor). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other embodiments, throttle/brake sensor 125 may be configured to measure a pressure applied to a pedal of the vehicle, such as a throttle or brake pedal.

Control system 106 may include components configured to assist in navigating vehicle 100, such as steering unit 132, throttle 134, brake unit 136, sensor fusion algorithm 138, computer vision system 140, navigation/pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some embodiments, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some embodiments, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software (e.g., a general purpose processor such as a central processing unit (CPU), a specialized processor such as a graphical processing unit (GPU) or a tensor processing unit (TPU), an application-specific integrated circuit (ASIC), a field programmable gate array (FPGA), a volatile memory, a non-volatile memory, or one or more machine-learned models) operable to process and analyze images in an effort to determine objects that are in motion (e.g., other vehicles, pedestrians, bicyclists, or animals) and objects that are not in motion (e.g., traffic lights, roadway boundaries, speedbumps, or potholes). As such, computer vision system 140 may use object recognition, Structure From Motion (SFM), video tracking, and other algorithms used in computer vision, for instance, to recognize objects, map an environment, track objects, estimate the speed of objects, etc.

Navigation/pathing system 142 may determine a driving path for vehicle 100, which may involve dynamically adjusting navigation during operation. As such, navigation/pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, interior microphone 150, and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may wirelessly communicate with one or more devices directly or via a communication network. For example, wireless communication system 146 could use 3G cellular communication, such as code-division multiple access (CDMA), evolution-data optimized (EVDO), global system for mobile communications (GSM)/general packet radio service (GPRS), or cellular communication, such as 4G worldwide interoperability for microwave access (WiMAX) or long-term evolution (LTE), or 5G. Alternatively, wireless communication system 146 may communicate with a wireless local area network (WLAN) using WIFI® or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some embodiments. For instance, power supply 110 may include one or more batteries configured to provide electrical power. Vehicle 100 may also use other types of power supplies. In an example embodiment, power supply 110 and energy source 119 may be integrated into a single energy source.

Vehicle 100 may also include computer system 112 to perform operations, such as operations described therein. As such, computer system 112 may include at least one processor 113 (which could include at least one microprocessor) operable to execute instructions 115 stored in a non-transitory, computer-readable medium, such as data storage 114. In some embodiments, computer system 112 may represent a plurality of computing devices that may serve to control individual components or subsystems of vehicle 100 in a distributed fashion.

In some embodiments, data storage 114 may contain instructions 115 (e.g., program logic) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, or control system 106), as well as from user interface 116. For example, computer system 112 may utilize input from sensor system 104 in order to estimate the output produced by propulsion system 102 and control system 106. Depending upon the embodiment, computer system 112 could be operable to monitor many aspects of vehicle 100 and its subsystems. In some embodiments, computer system 112 may disable some or all functions of the vehicle 100 based on signals received from sensor system 104.

The components of vehicle 100 could be configured to work in an interconnected fashion with other components within or outside their respective systems. For instance, in an example embodiment, camera 130 could capture a plurality of images that could represent information about a state of a surrounding environment of vehicle 100 operating in an autonomous or semi-autonomous mode. The state of the surrounding environment could include parameters of the road on which the vehicle is operating. For example, computer vision system 140 may be able to recognize the slope (grade) or other features based on the plurality of images of a roadway. Additionally, the combination of GPS 122 and the features recognized by computer vision system 140 may be used with map data stored in data storage 114 to determine specific road parameters. Further, radar 126 and/or lidar 128, and/or some other environmental mapping, ranging, and/or positioning sensor system may also provide information about the surroundings of the vehicle.

In other words, a combination of various sensors (which could be termed input-indication and output-indication sensors) and computer system 112 could interact to provide an indication of an input provided to control a vehicle or an indication of the surroundings of a vehicle.

In some embodiments, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors.

Although FIG. 1 shows various components of vehicle 100 (i.e., wireless communication system 146, computer system 112, data storage 114, and user interface 116) as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

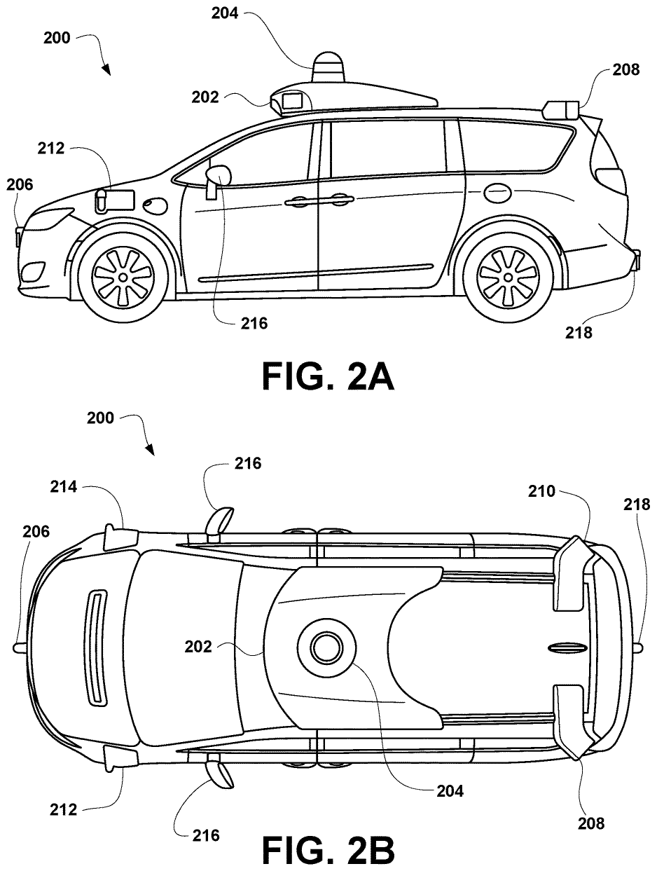

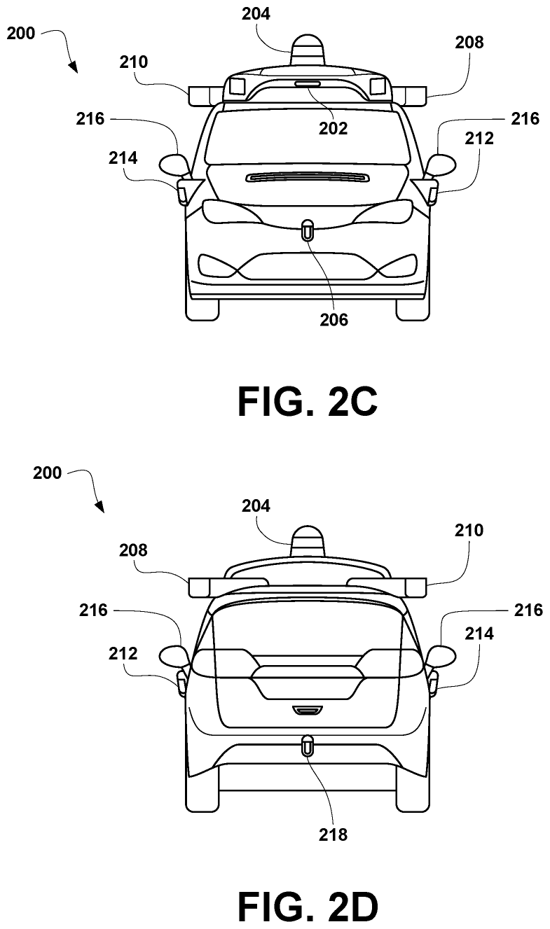

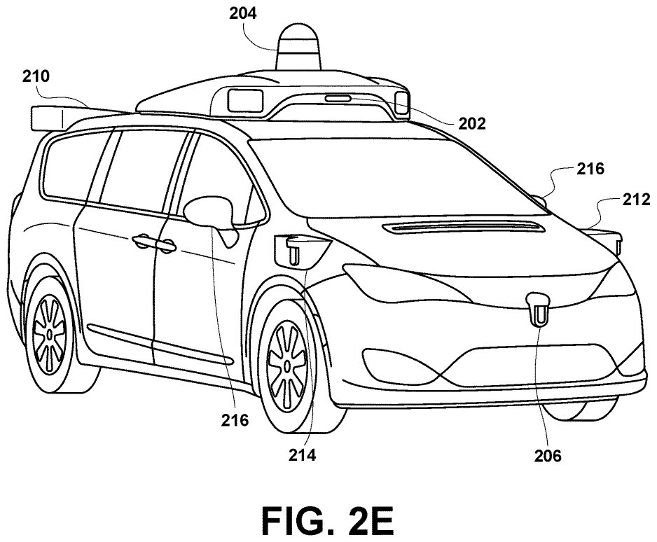

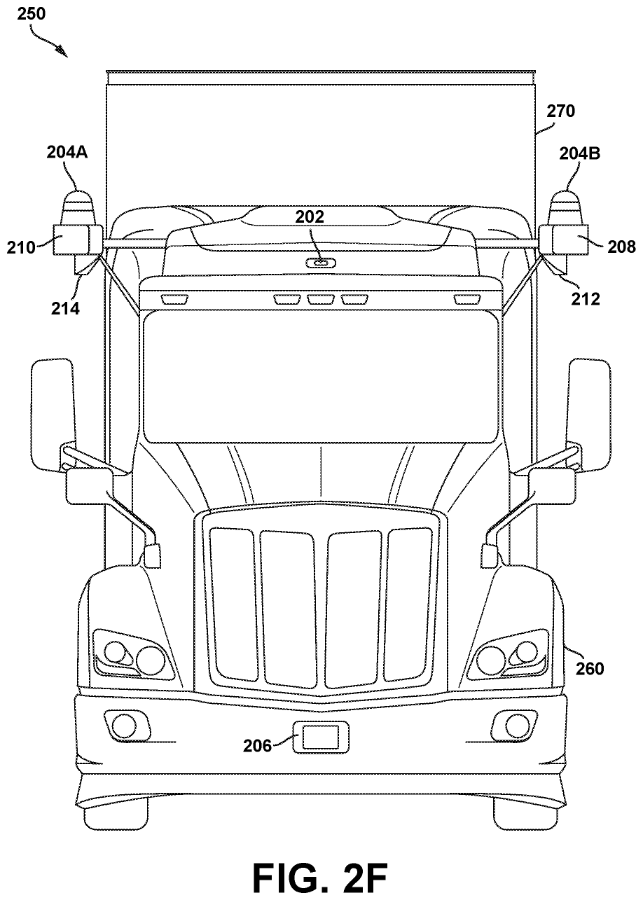

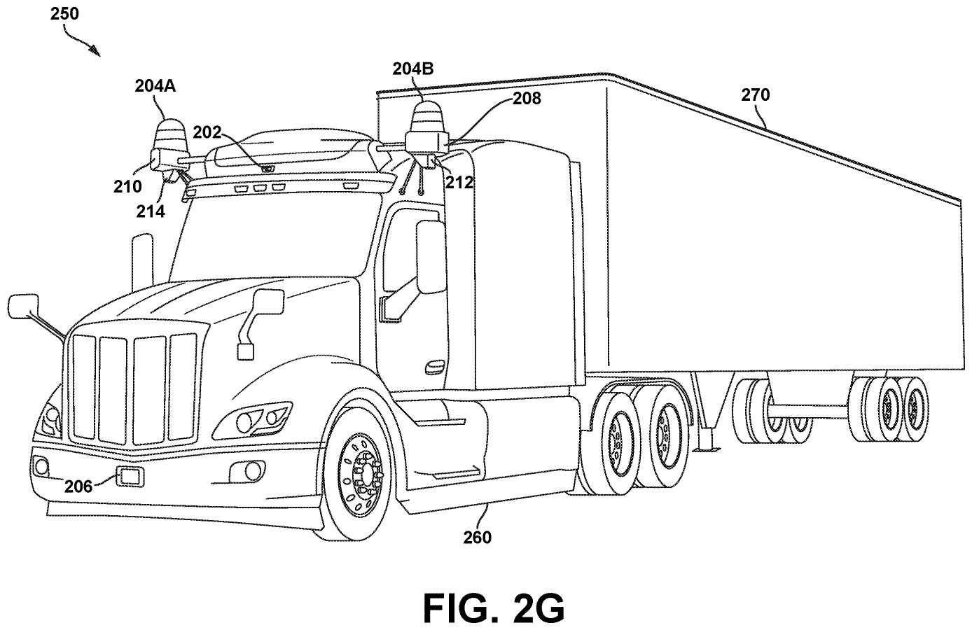

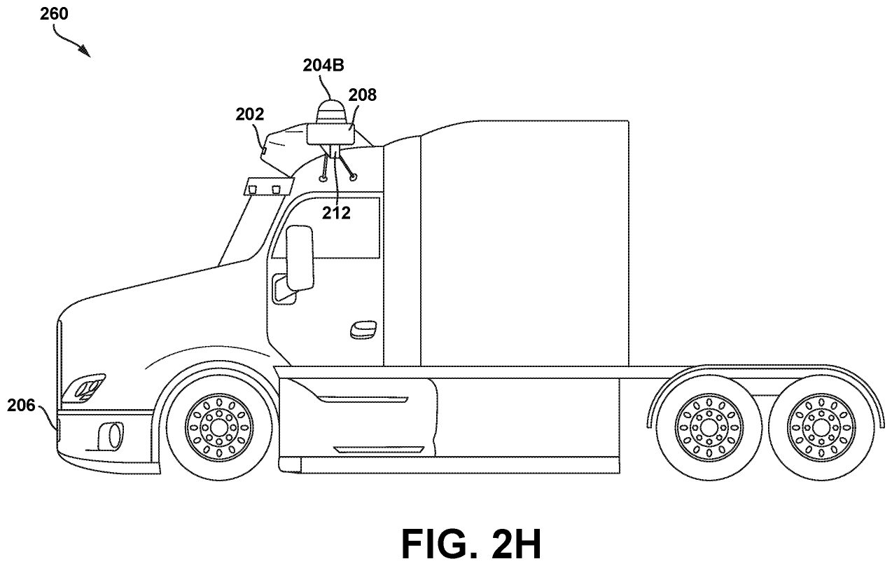

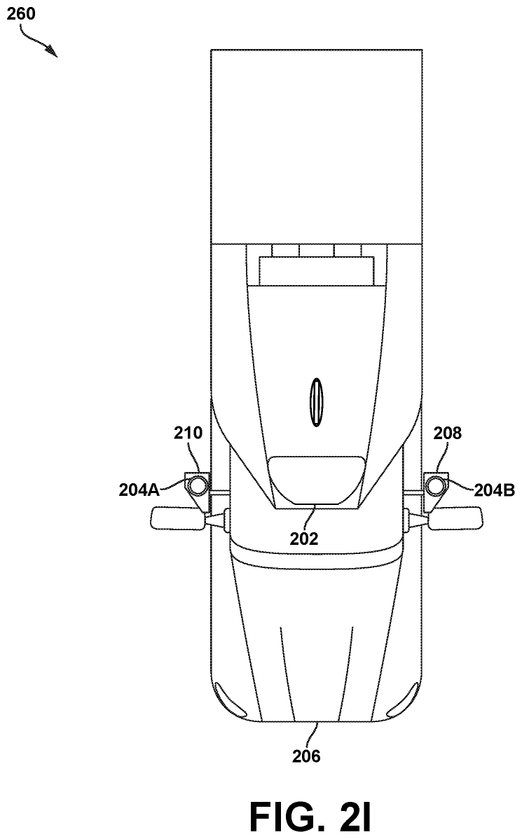

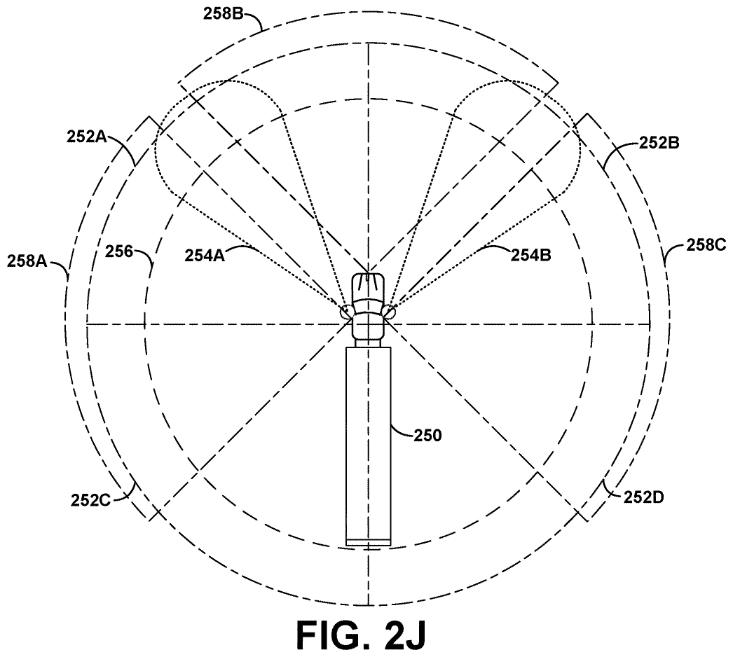

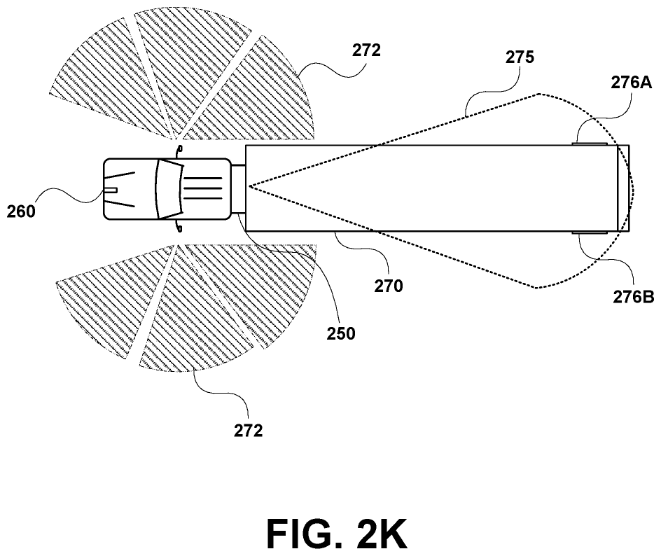

FIGS. 2A-2E show an example vehicle 200 (e.g., a fully autonomous vehicle or semi-autonomous vehicle) that can include some or all of the functions described in connection with vehicle 100 in reference to FIG. 1. Although vehicle 200 is illustrated in FIGS. 2A-2E as a van with side view mirrors for illustrative purposes, the present disclosure is not so limited. For instance, the vehicle 200 can represent a truck, a car, a semi-trailer truck, a motorcycle, a golf cart, an off-road vehicle, a farm vehicle, or any other vehicle that is described elsewhere herein (e.g., buses, boats, airplanes, helicopters, drones, lawn mowers, earth movers, submarines, all-terrain vehicles, snowmobiles, aircraft, recreational vehicles, amusement park vehicles, farm equipment, construction equipment or vehicles, warehouse equipment or vehicles, factory equipment or vehicles, trams, trains, trolleys, sidewalk delivery vehicles, and robot devices).

The example vehicle 200 may include one or more sensor systems 202, 204, 206, 208, 210, 212, 214, and 218. In some embodiments, sensor systems 202, 204, 206, 208, 210, 212, 214, and/or 218 could represent one or more optical systems (e.g. cameras), one or more lidars, one or more radars, one or more inertial sensors, one or more humidity sensors, one or more acoustic sensors (e.g., microphones or sonar devices), or one or more other sensors configured to sense information about an environment surrounding the vehicle 200. In other words, any sensor system now known or later created could be coupled to the vehicle 200 and/or could be utilized in conjunction with various operations of the vehicle 200. As an example, a lidar could be utilized in self-driving or other types of navigation, planning, perception, and/or mapping operations of the vehicle 200. In addition, sensor systems 202, 204, 206, 208, 210, 212, 214, and/or 218 could represent a combination of sensors described herein (e.g., one or more lidars and radars; one or more lidars and cameras; one or more cameras and radars; or one or more lidars, cameras, and radars).

Note that the number, location, and type of sensor systems (e.g., 202 and 204) depicted in FIGS. 2A-E are intended as a non-limiting example of the location, number, and type of such sensor systems of an autonomous or semi-autonomous vehicle. Alternative numbers, locations, types, and configurations of such sensors are possible (e.g., to comport with vehicle size, shape, aerodynamics, fuel economy, aesthetics, or other conditions, to reduce cost, or to adapt to specialized environmental or application circumstances). For example, the sensor systems (e.g., 202 and 204) could be disposed in various other locations on the vehicle (e.g., at location 216) and could have fields of view that correspond to internal and/or surrounding environments of the vehicle 200.

The sensor system 202 may be mounted atop the vehicle 200 and may include one or more sensors configured to detect information about an environment surrounding the vehicle 200, and output indications of the information. For example, sensor system 202 can include any combination of cameras, radars, lidars, inertial sensors, humidity sensors, and acoustic sensors (e.g., microphones or sonar devices). The sensor system 202 can include one or more movable mounts that could be operable to adjust the orientation of one or more sensors in the sensor system 202. In one embodiment, the movable mount could include a rotating platform that could scan sensors so as to obtain information from each direction around the vehicle 200. In another embodiment, the movable mount of the sensor system 202 could be movable in a scanning fashion within a particular range of angles and/or azimuths and/or elevations. The sensor system 202 could be mounted atop the roof of a car, although other mounting locations are possible.

Additionally, the sensors of sensor system 202 could be distributed in different locations and need not be collocated in a single location. Furthermore, each sensor of sensor system 202 can be configured to be moved or scanned independently of other sensors of sensor system 202. Additionally or alternatively, multiple sensors may be mounted at one or more of the sensor locations 202, 204, 206, 208, 210, 212, 214, and/or 218. For example, there may be two lidar devices mounted at a sensor location and/or there may be one lidar device and one radar mounted at a sensor location.

The one or more sensor systems 202, 204, 206, 208, 210, 212, 214, and/or 218 could include one or more lidar devices. For example, the lidar devices could include a plurality of light-emitter devices arranged over a range of angles with respect to a given plane (e.g., the x-y plane). For example, one or more of the sensor systems 202, 204, 206, 208, 210, 212, 214, and/or 218 may be configured to rotate or pivot about an axis (e.g., the z-axis) perpendicular to the given plane so as to illuminate an environment surrounding the vehicle 200 with light pulses. Based on detecting various aspects of reflected light pulses (e.g., the elapsed time of flight, polarization, or intensity), information about the surrounding environment may be determined.

In an example embodiment, sensor systems 202, 204, 206, 208, 210, 212, 214, and/or 218 may be configured to provide respective point cloud information that may relate to physical objects within the surrounding environment of the vehicle 200. While vehicle 200 and sensor systems 202, 204, 206, 208, 210, 212, 214, and 218 are illustrated as including certain features, it will be understood that other types of sensor systems are contemplated within the scope of the present disclosure. Further, the example vehicle 200 can include any of the components described in connection with vehicle 100 of FIG. 1.

In an example configuration, one or more radars can be located on vehicle 200. Similar to radar 126 described above, the one or more radars may include antennas configured to transmit and receive radio waves (e.g., electromagnetic waves having frequencies between 30 Hz and 300 GHz). Such radio waves may be used to determine the distance to and/or velocity of one or more objects in the surrounding environment of the vehicle 200. For example, one or more sensor systems 202, 204, 206, 208, 210, 212, 214, and/or 218 could include one or more radars. In some examples, one or more radars can be located near the rear of the vehicle 200 (e.g., sensor systems 208 and 210), to actively scan the environment near the back of the vehicle 200 for the presence of radio-reflective objects. Similarly, one or more radars can be located near the front of the vehicle 200 (e.g., sensor systems 212 or 214) to actively scan the environment near the front of the vehicle 200. A radar can be situated, for example, in a location suitable to illuminate a region including a forward-moving path of the vehicle 200 without occlusion by other features of the vehicle 200. For example, a radar can be embedded in and/or mounted in or near the front bumper, front headlights, cowl, and/or hood, etc. Furthermore, one or more additional radars can be located to actively scan the side and/or rear of the vehicle 200 for the presence of radio-reflective objects, such as by including such devices in or near the rear bumper, side panels, rocker panels, and/or undercarriage, etc.

The vehicle 200 can include one or more cameras. For example, the one or more sensor systems 202, 204, 206, 208, 210, 212, 214, and/or 218 could include one or more cameras. The camera can be a photosensitive instrument, such as a still camera, a video camera, a thermal imaging camera, a stereo camera, a night vision camera, etc., that is configured to capture a plurality of images of the surrounding environment of the vehicle 200. To this end, the camera can be configured to detect visible light, and can additionally or alternatively be configured to detect light from other portions of the spectrum, such as infrared or ultraviolet light. The camera can be a two-dimensional detector, and can optionally have a three-dimensional spatial range of sensitivity. In some embodiments, the camera can include, for example, a range detector configured to generate a two-dimensional image indicating distance from the camera to a number of points in the surrounding environment. To this end, the camera may use one or more range detecting techniques. For example, the camera can provide range information by using a structured light technique in which the vehicle 200 illuminates an object in the surrounding environment with a predetermined light pattern, such as a grid or checkerboard pattern and uses the camera to detect a reflection of the predetermined light pattern from environmental surroundings. Based on distortions in the reflected light pattern, the vehicle 200 can determine the distance to the points on the object. The predetermined light pattern may comprise infrared light, or radiation at other suitable wavelengths for such measurements. In some examples, the camera can be mounted inside a front windshield of the vehicle 200. Specifically, the camera can be situated to capture images from a forward-looking view with respect to the orientation of the vehicle 200. Other mounting locations and viewing angles of the camera can also be used, either inside or outside the vehicle 200. Further, the camera can have associated optics operable to provide an adjustable field of view. Still further, the camera can be mounted to vehicle 200 with a movable mount to vary a pointing angle of the camera, such as via a pan/tilt mechanism.

The vehicle 200 may also include one or more acoustic sensors (e.g., one or more of the sensor systems 202, 204, 206, 208, 210, 212, 214, 216, 218 may include one or more acoustic sensors) used to sense a surrounding environment of vehicle 200. Acoustic sensors may include microphones (e.g., piezoelectric microphones, condenser microphones, ribbon microphones, or microelectromechanical systems (MEMS) microphones) used to sense acoustic waves (i.e., pressure differentials) in a fluid (e.g., air) of the environment surrounding the vehicle 200. Such acoustic sensors may be used to identify sounds in the surrounding environment (e.g., sirens, human speech, animal sounds, or alarms) upon which control strategy for vehicle 200 may be based. For example, if the acoustic sensor detects a siren (e.g., an ambulatory siren or a fire engine siren), vehicle 200 may slow down and/or navigate to the edge of a roadway.

Although not shown in FIGS. 2A-2E, the vehicle 200 can include a wireless communication system (e.g., similar to the wireless communication system 146 of FIG. 1 and/or in addition to the wireless communication system 146 of FIG. 1). The wireless communication system may include wireless transmitters and receivers that could be configured to communicate with devices external or internal to the vehicle 200. Specifically, the wireless communication system could include transceivers configured to communicate with other vehicles and/or computing devices, for instance, in a vehicular communication system or a roadway station. Examples of such vehicular communication systems include DSRC, radio frequency identification (RFID), and other proposed communication standards directed towards intelligent transport systems.

The vehicle 200 may include one or more other components in addition to or instead of those shown. The additional components may include electrical or mechanical functionality.

A control system of the vehicle 200 may be configured to control the vehicle 200 in accordance with a control strategy from among multiple possible control strategies. The control system may be configured to receive information from sensors coupled to the vehicle 200 (on or off the vehicle 200), modify the control strategy (and an associated driving behavior) based on the information, and control the vehicle 200 in accordance with the modified control strategy. The control system further may be configured to monitor the information received from the sensors, and continuously evaluate driving conditions; and also may be configured to modify the control strategy and driving behavior based on changes in the driving conditions. For example, a route taken by a vehicle from one destination to another may be modified based on driving conditions. Additionally or alternatively, the velocity, acceleration, turn angle, follow distance (i.e., distance to a vehicle ahead of the present vehicle), lane selection, etc. could all be modified in response to changes in the driving conditions.

As described above, in some embodiments, the vehicle 200 may take the form of a van, but alternate forms are also possible and are contemplated herein. As such, FIGS. 2F-2I illustrate embodiments where a vehicle 250 takes the form of a semi-truck. For example, FIG. 2F illustrates a front-view of the vehicle 250 and FIG. 2G illustrates an isometric view of the vehicle 250. In embodiments where the vehicle 250 is a semi-truck, the vehicle 250 may include a tractor portion 260 and a trailer portion 270 (illustrated in FIG. 2G). FIGS. 2H and 2I provide a side view and a top view, respectively, of the tractor portion 260. Similar to the vehicle 200 illustrated above, the vehicle 250 illustrated in FIGS. 2F-2I may also include a variety of sensor systems (e.g., similar to the sensor systems 202, 206, 208, 210, 212, 214 shown and described with reference to FIGS. 2A-2E). In some embodiments, whereas the vehicle 200 of FIGS. 2A-2E may only include a single copy of some sensor systems (e.g., the sensor system 204), the vehicle 250 illustrated in FIGS. 2F-2I may include multiple copies of that sensor system (e.g., the sensor systems 204A and 204B, as illustrated).

While drawings and description throughout may reference a given form of vehicle (e.g., the semi-truck vehicle 250 or the van vehicle 200), it is understood that embodiments described herein can be equally applied in a variety of vehicle contexts (e.g., with modifications employed to account for a form factor of vehicle). For example, sensors and/or other components described or illustrated as being part of the van vehicle 200 could also be used (e.g., for navigation and/or obstacle detection and avoidance) in the semi-truck vehicle 250

FIG. 2J illustrates various sensor fields of view (e.g., associated with the vehicle 250 described above). As described above, vehicle 250 may contain a plurality of sensors/sensor units. The locations of the various sensors may correspond to the locations of the sensors disclosed in FIGS. 2F-2I, for example. However, in some instances, the sensors may have other locations. Sensors location reference numbers are omitted from FIG. 2J for simplicity of the drawing. For each sensor unit of vehicle 250, FIG. 2J illustrates a representative field of view (e.g., fields of view labeled as 252A, 252B, 252C, 252D, 254A, 254B, 256, 258A, 258B, and 258C). The field of view of a sensor may include an angular region (e.g., an azimuthal angular region and/or an elevational angular region) over which the sensor may detect objects.

FIG. 2K illustrates beam steering for a sensor of a vehicle (e.g., the vehicle 250 shown and described with reference to FIGS. 2F-2J), according to example embodiments. In various embodiments, a sensor unit of vehicle 250 may be a radar, a lidar, a sonar, etc. Further, in some embodiments, during the operation of the sensor, the sensor may be scanned within the field of view of the sensor. Various different scanning angles for an example sensor are shown as regions 272, which each indicate the angular region over which the sensor is operating. The sensor may periodically or iteratively change the region over which it is operating. In some embodiments, multiple sensors may be used by vehicle 250 to measure regions 272. In addition, other regions may be included in other examples. For instance, one or more sensors may measure aspects of the trailer 270 of vehicle 250 and/or a region directly in front of vehicle 250.

At some angles, region of operation 275 of the sensor may include rear wheels 276A, 276B of trailer 270. Thus, the sensor may measure rear wheel 276A and/or rear wheel 276B during operation. For example, rear wheels 276A, 276B may reflect lidar signals or radar signals transmitted by the sensor. The sensor may receive the reflected signals from rear wheels 276A, 276. Therefore, the data collected by the sensor may include data from the reflections off the wheel.

In some instances, such as when the sensor is a radar, the reflections from rear wheels 276A, 276B may appear as noise in the received radar signals. Consequently, the radar may operate with an enhanced signal to noise ratio in instances where rear wheels 276A, 276B direct radar signals away from the sensor.

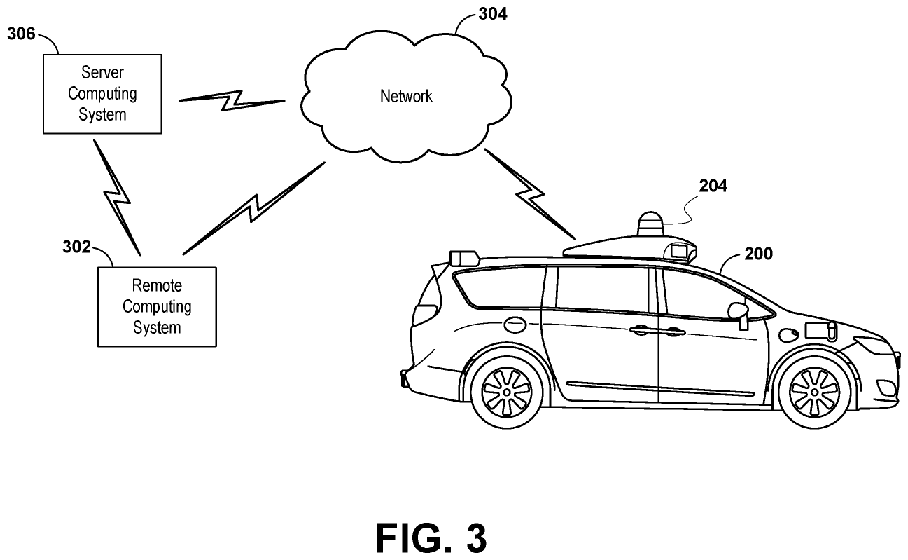

FIG. 3 is a conceptual illustration of wireless communication between various computing systems related to an autonomous or semi-autonomous vehicle, according to example embodiments. In particular, wireless communication may occur between remote computing system 302 and vehicle 200 via network 304. Wireless communication may also occur between server computing system 306 and remote computing system 302, and between server computing system 306 and vehicle 200.

Vehicle 200 can correspond to various types of vehicles capable of transporting passengers or objects between locations, and may take the form of any one or more of the vehicles discussed above. In some instances, vehicle 200 may operate in an autonomous or semi-autonomous mode that enables a control system to safely navigate vehicle 200 between destinations using sensor measurements. When operating in an autonomous or semi-autonomous mode, vehicle 200 may navigate with or without passengers. As a result, vehicle 200 may pick up and drop off passengers between desired destinations.

Remote computing system 302 may represent any type of device related to remote assistance techniques, including but not limited to those described herein. Within examples, remote computing system 302 may represent any type of device configured to (i) receive information related to vehicle 200, (ii) provide an interface through which a human operator can in turn perceive the information and input a response related to the information, and (iii) transmit the response to vehicle 200 or to other devices. Remote computing system 302 may take various forms, such as a workstation, a desktop computer, a laptop, a tablet, a mobile phone (e.g., a smart phone), and/or a server. In some examples, remote computing system 302 may include multiple computing devices operating together in a network configuration.

Remote computing system 302 may include one or more subsystems and components similar or identical to the subsystems and components of vehicle 200. At a minimum, remote computing system 302 may include a processor configured for performing various operations described herein. In some embodiments, remote computing system 302 may also include a user interface that includes input/output devices, such as a touchscreen and a speaker. Other examples are possible as well.

Network 304 represents infrastructure that enables wireless communication between remote computing system 302 and vehicle 200. Network 304 also enables wireless communication between server computing system 306 and remote computing system 302, and between server computing system 306 and vehicle 200.

The position of remote computing system 302 can vary within examples. For instance, remote computing system 302 may have a remote position from vehicle 200 that has a wireless communication via network 304. In another example, remote computing system 302 may correspond to a computing device within vehicle 200 that is separate from vehicle 200, but with which a human operator can interact while a passenger or driver of vehicle 200. In some examples, remote computing system 302 may be a computing device with a touchscreen operable by the passenger of vehicle 200.

In some embodiments, operations described herein that are performed by remote computing system 302 may be additionally or alternatively performed by vehicle 200 (i.e., by any system(s) or subsystem(s) of vehicle 200). In other words, vehicle 200 may be configured to provide a remote assistance mechanism with which a driver or passenger of the vehicle can interact.

Server computing system 306 may be configured to wirelessly communicate with remote computing system 302 and vehicle 200 via network 304 (or perhaps directly with remote computing system 302 and/or vehicle 200). Server computing system 306 may represent any computing device configured to receive, store, determine, and/or send information relating to vehicle 200 and the remote assistance thereof. As such, server computing system 306 may be configured to perform any operation(s), or portions of such operation(s), that is/are described herein as performed by remote computing system 302 and/or vehicle 200. Some embodiments of wireless communication related to remote assistance may utilize server computing system 306, while others may not.

Server computing system 306 may include one or more subsystems and components similar or identical to the subsystems and components of remote computing system 302 and/or vehicle 200, such as a processor configured for performing various operations described herein, and a wireless communication interface for receiving information from, and providing information to, remote computing system 302 and vehicle 200.

The various systems described above may perform various operations. These operations and related features will now be described.

In line with the discussion above, a computing system (e.g., remote computing system 302, server computing system 306, or a computing system local to vehicle 200) may operate to use a camera to capture images of the surrounding environment of an autonomous or semi-autonomous vehicle. In general, at least one computing system will be able to analyze the images and possibly control the autonomous or semi-autonomous vehicle.

In some embodiments, to facilitate autonomous or semi-autonomous operation, a vehicle (e.g., vehicle 200) may receive data representing objects in an environment surrounding the vehicle (also referred to herein as “environment data”) in a variety of ways. A sensor system on the vehicle may provide the environment data representing objects of the surrounding environment. For example, the vehicle may have various sensors, including a camera, a radar, a lidar, a microphone, a radio unit, and other sensors. Each of these sensors may communicate environment data to a processor in the vehicle about information each respective sensor receives.

In one example, a camera may be configured to capture still images and/or video. In some embodiments, the vehicle may have more than one camera positioned in different orientations. Also, in some embodiments, the camera may be able to move to capture images and/or video in different directions. The camera may be configured to store captured images and video to a memory for later processing by a processing system of the vehicle. The captured images and/or video may be the environment data. Further, the camera may include an image sensor as described herein.

In another example, a radar may be configured to transmit an electromagnetic signal that will be reflected by various objects near the vehicle, and then capture electromagnetic signals that reflect off the objects. The captured reflected electromagnetic signals may enable the radar (or processing system) to make various determinations about objects that reflected the electromagnetic signal. For example, the distances to and positions of various reflecting objects may be determined. In some embodiments, the vehicle may have more than one radar in different orientations. The radar may be configured to store captured information to a memory for later processing by a processing system of the vehicle. The information captured by the radar may be environment data.

In another example, a lidar may be configured to transmit an electromagnetic signal (e.g., infrared light, such as that from a gas or diode laser, or other possible light source) that will be reflected by target objects near the vehicle. The lidar may be able to capture the reflected electromagnetic (e.g., infrared light) signals. The captured reflected electromagnetic signals may enable the range-finding system (or processing system) to determine a range to various objects. The lidar may also be able to determine a velocity or speed of target objects and store it as environment data.

Additionally, in an example, a microphone may be configured to capture audio of the environment surrounding the vehicle. Sounds captured by the microphone may include emergency vehicle sirens and the sounds of other vehicles. For example, the microphone may capture the sound of the siren of an ambulance, fire engine, or police vehicle. A processing system may be able to identify that the captured audio signal is indicative of an emergency vehicle. In another example, the microphone may capture the sound of an exhaust of another vehicle, such as that from a motorcycle. A processing system may be able to identify that the captured audio signal is indicative of a motorcycle. The data captured by the microphone may form a portion of the environment data.

In yet another example, the radio unit may be configured to transmit an electromagnetic signal that may take the form of a Bluetooth signal, 802.11 signal, and/or other radio technology signal. The first electromagnetic radiation signal may be transmitted via one or more antennas located in a radio unit. Further, the first electromagnetic radiation signal may be transmitted with one of many different radio-signaling modes. However, in some embodiments it is desirable to transmit the first electromagnetic radiation signal with a signaling mode that requests a response from devices located near the autonomous or semi-autonomous vehicle. The processing system may be able to detect nearby devices based on the responses communicated back to the radio unit and use this communicated information as a portion of the environment data.

In some embodiments, the processing system may be able to combine information from the various sensors in order to make further determinations of the surrounding environment of the vehicle. For example, the processing system may combine data from both radar information and a captured image to determine if another vehicle or pedestrian is in front of the autonomous or semi-autonomous vehicle. In other embodiments, other combinations of sensor data may be used by the processing system to make determinations about the surrounding environment.

While operating in an autonomous mode (or semi-autonomous mode), the vehicle may control its operation with little-to-no human input. For example, a human-operator may enter an address into the vehicle and the vehicle may then be able to drive, without further input from the human (e.g., the human does not have to steer or touch the brake/gas pedals), to the specified destination. Further, while the vehicle is operating autonomously or semi-autonomously, the sensor system may be receiving environment data. The processing system of the vehicle may alter the control of the vehicle based on environment data received from the various sensors. In some examples, the vehicle may alter a velocity of the vehicle in response to environment data from the various sensors. The vehicle may change velocity in order to avoid obstacles, obey traffic laws, etc. When a processing system in the vehicle identifies objects near the vehicle, the vehicle may be able to change velocity, or alter the movement in another way.

When the vehicle detects an object but is not highly confident in the detection of the object, the vehicle can request a human operator (or a more powerful computer) to perform one or more remote assistance tasks, such as (i) confirm whether the object is in fact present in the surrounding environment (e.g., if there is actually a stop sign or if there is actually no stop sign present), (ii) confirm whether the vehicle's identification of the object is correct, (iii) correct the identification if the identification was incorrect, and/or (iv) provide a supplemental instruction (or modify a present instruction) for the autonomous or semi-autonomous vehicle. Remote assistance tasks may also include the human operator providing an instruction to control operation of the vehicle (e.g., instruct the vehicle to stop at a stop sign if the human operator determines that the object is a stop sign), although in some scenarios, the vehicle itself may control its own operation based on the human operator's feedback related to the identification of the object.

To facilitate this, the vehicle may analyze the environment data representing objects of the surrounding environment to determine at least one object having a detection confidence below a threshold. A processor in the vehicle may be configured to detect various objects of the surrounding environment based on environment data from various sensors. For example, in one embodiment, the processor may be configured to detect objects that may be important for the vehicle to recognize. Such objects may include pedestrians, bicyclists, street signs, other vehicles, indicator signals on other vehicles, and other various objects detected in the captured environment data.

The detection confidence may be indicative of a likelihood that the determined object is correctly identified in the surrounding environment, or is present in the surrounding environment. For example, the processor may perform object detection of objects within image data in the received environment data, and determine that at least one object has the detection confidence below the threshold based on being unable to identify the object with a detection confidence above the threshold. If a result of an object detection or object recognition of the object is inconclusive, then the detection confidence may be low or below the set threshold.

The vehicle may detect objects of the surrounding environment in various ways depending on the source of the environment data. In some embodiments, the environment data may come from a camera and be image or video data. In other embodiments, the environment data may come from a lidar. The vehicle may analyze the captured image or video data to identify objects in the image or video data. The methods and apparatuses may be configured to monitor image and/or video data for the presence of objects of the surrounding environment. In other embodiments, the environment data may be radar, audio, or other data. The vehicle may be configured to identify objects of the surrounding environment based on the radar, audio, or other data.

In some embodiments, the techniques the vehicle uses to detect objects may be based on a set of known data. For example, data related to environmental objects may be stored to a memory located in the vehicle. The vehicle may compare received data to the stored data to determine objects. In other embodiments, the vehicle may be configured to determine objects based on the context of the data. For example, street signs related to construction may generally have an orange color. Accordingly, the vehicle may be configured to detect objects that are orange, and located near the side of roadways as construction-related street signs. Additionally, when the processing system of the vehicle detects objects in the captured data, it also may calculate a confidence for each object.

Further, the vehicle may also have a confidence threshold. The confidence threshold may vary depending on the type of object being detected. For example, the confidence threshold may be lower for an object that may require a quick responsive action from the vehicle, such as brake lights on another vehicle. However, in other embodiments, the confidence threshold may be the same for all detected objects. When the confidence associated with a detected object is greater than the confidence threshold, the vehicle may assume the object was correctly recognized and responsively adjust the control of the vehicle based on that assumption.

When the confidence associated with a detected object is less than the confidence threshold, the actions that the vehicle takes may vary. In some embodiments, the vehicle may react as if the detected object is present despite the low confidence level. In other embodiments, the vehicle may react as if the detected object is not present.

When the vehicle detects an object of the surrounding environment, it may also calculate a confidence associated with the specific detected object. The confidence may be calculated in various ways depending on the embodiment. In one example, when detecting objects of the surrounding environment, the vehicle may compare environment data to predetermined data relating to known objects. The closer the match between the environment data and the predetermined data, the higher the confidence. In other embodiments, the vehicle may use mathematical analysis of the environment data to determine the confidence associated with the objects.

In response to determining that an object has a detection confidence that is below the threshold, the vehicle may transmit, to the remote computing system, a request for remote assistance with the identification of the object. As discussed above, the remote computing system may take various forms. For example, the remote computing system may be a computing device within the vehicle that is separate from the vehicle, but with which a human operator can interact while a passenger or driver of the vehicle, such as a touchscreen interface for displaying remote assistance information. Additionally or alternatively, as another example, the remote computing system may be a remote computer terminal or other device that is located at a location that is not near the vehicle.

The request for remote assistance may include the environment data that includes the object, such as image data, audio data, etc. The vehicle may transmit the environment data to the remote computing system over a network (e.g., network 304), and in some embodiments, via a server (e.g., server computing system 306). The human operator of the remote computing system may in turn use the environment data as a basis for responding to the request.

In some embodiments, when the object is detected as having a confidence below the confidence threshold, the object may be given a preliminary identification, and the vehicle may be configured to adjust the operation of the vehicle in response to the preliminary identification. Such an adjustment of operation may take the form of stopping the vehicle, switching the vehicle to a human-controlled mode, changing a velocity of the vehicle (e.g., a speed and/or direction), among other possible adjustments.

In other embodiments, even if the vehicle detects an object having a confidence that meets or exceeds the threshold, the vehicle may operate in accordance with the detected object (e.g., come to a stop if the object is identified with high confidence as a stop sign), but may be configured to request remote assistance at the same time as (or at a later time from) when the vehicle operates in accordance with the detected object.

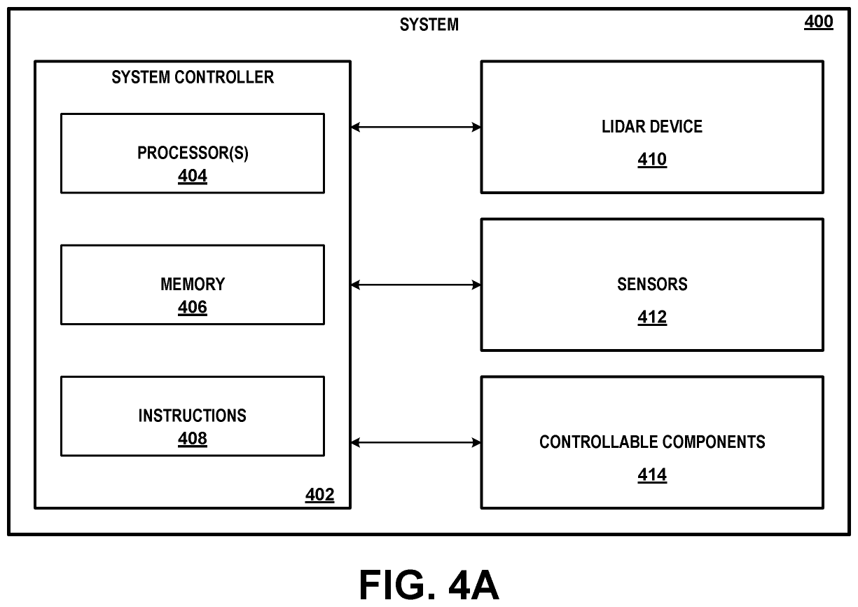

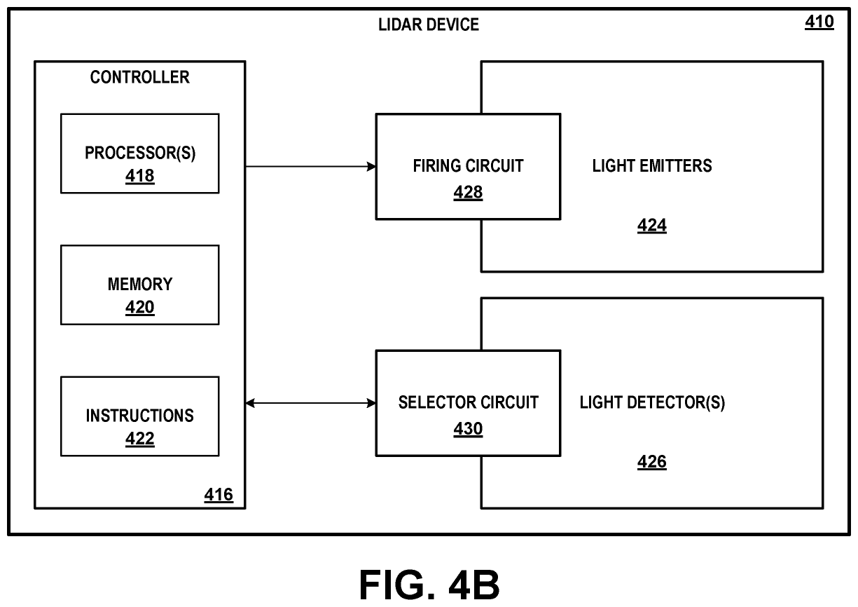

FIG. 4A is a block diagram of a system, according to example embodiments. In particular, FIG. 4A shows a system 400 that includes a system controller 402, a lidar device 410, a plurality of sensors 412, and a plurality of controllable components 414. System controller 402 includes processor(s) 404, a memory 406, and instructions 408 stored on the memory 406 and executable by the processor(s) 404 to perform functions.

The processor(s) 404 can include one or more processors, such as one or more general-purpose microprocessors (e.g., having a single core or multiple cores) and/or one or more special purpose microprocessors. The one or more processors may include, for instance, one or more central processing units (CPUs), one or more microcontrollers, one or more graphical processing units (GPUs), one or more tensor processing units (TPUs), one or more ASICs, and/or one or more field-programmable gate arrays (FPGAs). Other types of processors, computers, or devices configured to carry out software instructions are also contemplated herein.

The memory 406 may include a computer-readable medium, such as a non-transitory, computer-readable medium, which may include without limitation, read-only memory (ROM), programmable read-only memory (PROM), erasable programmable read-only memory (EPROM), electrically erasable programmable read-only memory (EEPROM), non-volatile random-access memory (e.g., flash memory), a solid state drive (SSD), a hard disk drive (HDD), a Compact Disc (CD), a Digital Video Disk (DVD), a digital tape, read/write (R/W) CDs, R/W DVDs, etc.

The lidar device 410, described further below, includes a plurality of light emitters configured to emit light (e.g., in light pulses) and one or more light detectors configured to detect light (e.g., reflected portions of the light pulses). The lidar device 410 may generate three-dimensional (3D) point cloud data from outputs of the light detector(s), and provide the 3D point cloud data to the system controller 402. The system controller 402, in turn, may perform operations on the 3D point cloud data to determine the characteristics of a surrounding environment (e.g., relative positions of objects within a surrounding environment, edge detection, object detection, or proximity sensing).

Similarly, the system controller 402 may use outputs from the plurality of sensors 412 to determine the characteristics of the system 400 and/or characteristics of the surrounding environment. For example, the sensors 412 may include one or more of a GPS, an IMU, an image capture device (e.g., a camera), a light sensor, a heat sensor, and other sensors indicative of parameters relevant to the system 400 and/or the surrounding environment. The lidar device 410 is depicted as separate from the sensors 412 for purposes of example, and may be considered as part of or as the sensors 412 in some examples.

Based on characteristics of the system 400 and/or the surrounding environment determined by the system controller 402 based on the outputs from the lidar device 410 and the sensors 412, the system controller 402 may control the controllable components 414 to perform one or more actions. For example, the system 400 may correspond to a vehicle, in which case the controllable components 414 may include a braking system, a turning system, and/or an accelerating system of the vehicle, and the system controller 402 may change aspects of these controllable components based on characteristics determined from the lidar device 410 and/or sensors 412 (e.g., when the system controller 402 controls the vehicle in an autonomous or semi-autonomous mode). Within examples, the lidar device 410 and the sensors 412 are also controllable by the system controller 402.

FIG. 4B is a block diagram of a lidar device, according to an example embodiment. In particular, FIG. 4B shows a lidar device 410, having a controller 416 configured to control a plurality of light emitters 424 and one or more light detector(s), e.g., a plurality of light detectors 426, etc. The lidar device 410 further includes a firing circuit 428 configured to select and provide power to respective light emitters of the plurality of light emitters 424 and may include a selector circuit 430 configured to select respective light detectors of the plurality of light detectors 426. The controller 416 includes processor(s) 418, a memory 420, and instructions 422 stored on the memory 420.

Similar to processor(s) 404, the processor(s) 418 can include one or more processors, such as one or more general-purpose microprocessors and/or one or more special purpose microprocessors. The one or more processors may include, for instance, one or more CPUs, one or more microcontrollers, one or more GPUs, one or more TPUs, one or more ASICs, and/or one or more FPGAs. Other types of processors, computers, or devices configured to carry out software instructions are also contemplated herein.

Similar to memory 406, the memory 420 may include a computer-readable medium, such as a non-transitory, computer-readable medium, such as, but not limited to, ROM, PROM, EPROM, EEPROM, non-volatile random-access memory (e.g., flash memory), a SSD, a HDD, a CD, a DVD, a digital tape, R/W CDs, R/W DVDs, etc.

The instructions 422 are stored on memory 420 and executable by the processor(s) 418 to perform functions related to controlling the firing circuit 428 and the selector circuit 430, for generating 3D point cloud data, and for processing the 3D point cloud data (or perhaps facilitating processing the 3D point cloud data by another computing device, such as the system controller 402).

The controller 416 can determine 3D point cloud data by using the light emitters 424 to emit pulses of light. A time of emission is established for each light emitter and a relative location at the time of emission is also tracked. Aspects of a surrounding environment of the lidar device 410, such as various objects, reflect the pulses of light. For example, when the lidar device 410 is in a surrounding environment that includes a road, such objects may include vehicles, signs, pedestrians, road surfaces, or construction cones. Some objects may be more reflective than others, such that an intensity of reflected light may indicate a type of object that reflects the light pulses. Further, surfaces of objects may be at different positions relative to the lidar device 410, and thus take more or less time to reflect portions of light pulses back to the lidar device 410. Accordingly, the controller 416 may track a detection time at which a reflected light pulse is detected by a light detector and a relative position of the light detector at the detection time. By measuring time differences between emission times and detection times, the controller 416 can determine how far the light pulses travel prior to being received, and thus a relative distance of a corresponding object. By tracking relative positions at the emission times and detection times the controller 416 can determine an orientation of the light pulse and reflected light pulse relative to the lidar device 410, and thus a relative orientation of the object. By tracking intensities of received light pulses, the controller 416 can determine how reflective the object is. The 3D point cloud data determined based on this information may thus indicate relative positions of detected reflected light pulses (e.g., within a coordinate system, such as a Cartesian coordinate system) and intensities of each reflected light pulse.

The firing circuit 428 is used for selecting light emitters for emitting light pulses. The selector circuit 430 similarly is used for sampling outputs from light detectors.

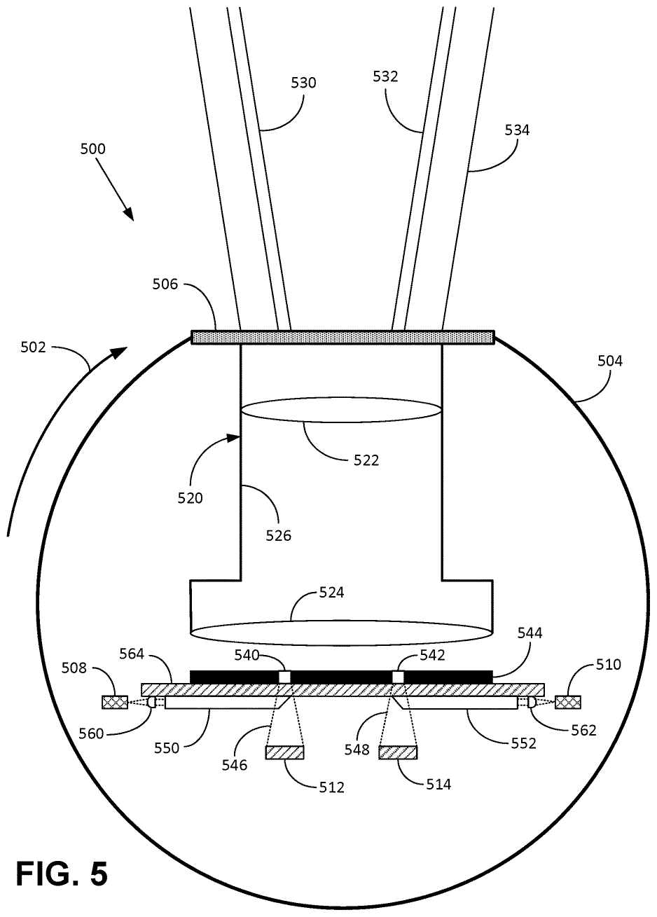

FIG. 5 is a sectional view of a lidar device 500, according to example embodiments. In this example, lidar device 500 is configured to rotate about an axis of rotation in a rotation direction 502. The sectional view of FIG. 5 is in a plane perpendicular to the axis of rotation. The axis of rotation could be a vertical axis, such that the rotation in the rotation direction 502 enables the lidar device 500 to scan a range of azimuthal angles in the environment. Alternatively or additionally, lidar device 500 could rotate about a horizontal axis to scan a range of elevational angles or could be configured to scan a portion of the environment in some other way.

As shown, lidar device 500 includes various optical components that are enclosed within a housing 504 and an optical window 506. The optical components of lidar device 500 include a plurality of light emitters, exemplified by light emitters 508 and 510 and a plurality of detectors, exemplified by detectors 512 and 514. Light emitters 508 and 510 could be laser diodes, vertical-cavity surface-emitting lasers (VCSELs), fiber lasers, light emitting diodes (LEDs), or other types of light sources. The light emitted by light emitters 508 and 510 could have wavelengths in the ultraviolet, visible, and/or infrared portions of the electromagnetic spectrum. In one example, light emitters 508 and 510 are laser diodes that emit light at a wavelength of about 905 nanometers.

In lidar device 500, light emitter 508 is paired with detector 512 to provide a first transmit/receive channel, and light emitter 510 is paired with detector 514 to provide a second transmit/receive channel. Although FIG. 5 shows two light emitters and two detectors, it is to be understood that lidar device 500 could include any number of light emitters and detectors to provide any number of transmit/receive channels.

In this example, lidar device 500 includes a telecentric lens assembly 520 that includes a plurality of lenses, exemplified by lenses 522 and 524, mounted in a lens barrel/baffle structure 526 that is coupled to the optical window 506. The telecentric lens assembly 520 is arranged to direct light emitted from the light emitters 508 and 510 through the optical window 506 into the environment of the lidar device 500, so as to illuminate fields of view 530 and 532, respectively. The telecentric lens assembly 520 is further arranged to direct reflected light from the environment that enters the lidar device 500 through the optical window 506 from within the fields of view 530 and 532 toward the detectors 512 and 514, respectively. As shown, the fields of view 530 and 532 are part of an overall field of view 534 of lidar device 500.

The fields of view 530 and 532 are defined, in part, by apertures 540 and 542, respectively. The apertures 540 and 542 may be pinhole apertures (e.g., with diameters between 100 microns and 500 microns) formed in an opaque material, shown as an aperture plate 544. For purposes of illustration, FIG. 5 shows only two apertures. However, it is to be understood that the aperture plate 544 may include any number of apertures, with each aperture defining a respective field of view for a respective transmit/receive channel that includes a respective light emitter and a respective detector. The apertures in the aperture plate 544 could be arranged in a one-dimensional array, a two-dimensional array, or in some other pattern. The various fields of view of the transmit/receive channels may together provide the lidar device 500 with the overall field of view 534.

The apertures 540 and 542 are positioned at a focal plane of the telecentric lens assembly 520 between the telecentric lens assembly 520 and the detectors 512 and 514. With this configuration, light from the fields of view 530 and 532 is focused within the apertures 540 and 542, respectively, by the telecentric lens assembly 520, and the focused light thereafter diverges toward the detectors 512 and 514. As shown, detector 512 intercepts diverging light 546 from aperture 540 and detector 514 intercepts diverging light 548 from aperture 542. Advantageously, the detectors 512 and 514 may each include an array of single photon detectors that covers an area that generally matches the area illuminated by the diverging light 546 and 548, so as to provide for single photon detection with a high dynamic range. For example, the detectors 512 and 514 may each include a SiPM. Alternatively, each of detectors 512 and 514 may include one or more avalanche photodiodes (APDs), charge-coupled devices (CCDs), active-pixel sensors, or other types of light sensing devices.

As shown, the light emitted by light emitters 508 and 510 is directed to the apertures 540 and 542 by optical waveguides 550 and 552, respectively. More particularly, the light emitted by light emitters 508 and 510 is coupled into input ends of the optical waveguides 550 and 552 via respective lenses 560 and 562, and the optical waveguides 550 and 552 guide the light by total internal reflection from their respective input ends to respective output ends that are positioned proximate the apertures 540 and 542. The output ends of the optical waveguides 550 and 552 include reflective angled surfaces that reflect at least a portion of the guided light out of the optical waveguides 550 and 552 toward the apertures 540 and 542, respectively. The telecentric lens assembly 520 collimates the light emitted from the light guides 550 and 552 through the apertures 540 and 542 and transmits the collimated light through the optical window 506 into the fields of view 530 and 532, respectively.

Lenses 560 and 562 could focus, collimate, or otherwise direct the light emitted by light emitters 508 and 510 into optical waveguides 550 and 552, respectively, depending on the implementation. In some embodiments, each of the light emitters 508 and 510 is a laser diode that emits light that diverges along a fast axis and a slow axis. In such embodiments, lenses 560 and 562 could be FAC lenses that at least partially collimate the light along the fast axis so as to reduce the divergence of the emitted light along the fast axis. The fast axis could be in the plane of FIG. 5, and the slow axis could be perpendicular to the plane of FIG. 5. However, other configurations are possible as well.

As shown, optical waveguides 550 and 552 could be mounted on a first side of a substrate 564. The substrate 564 could be composed of glass, plastic, or other material that is transparent to the wavelengths of light emitted by light emitters 508 and 510. Lenses 560 and 562 could also be mounted to the first side of substrate 564. The aperture plate 544 could be mounted to a second side of substrate 564 that is opposite the first side of substrate 564.

Although FIG. 5 shows each of lenses 560 and 562 optically coupling one light emitter to one optical waveguide, each of lenses 560 and 562 could optically couple a plurality of light emitters to a corresponding plurality of optical waveguides.

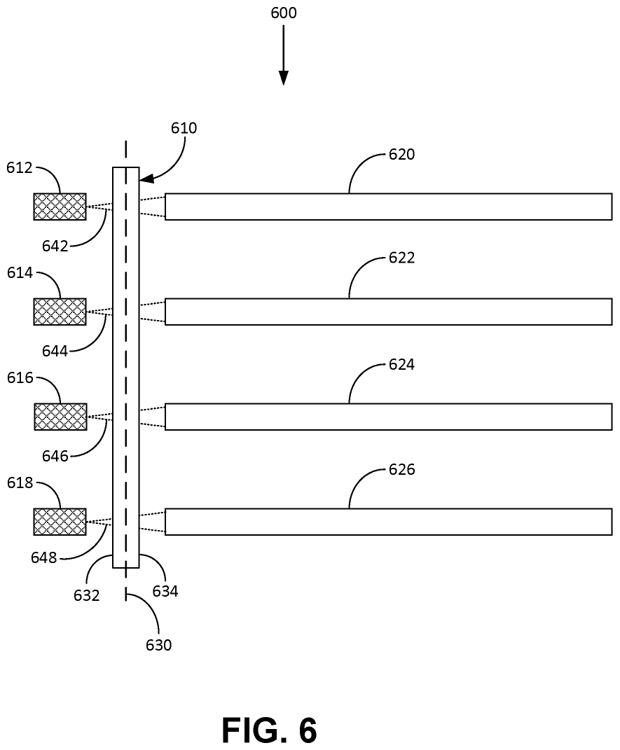

FIG. 6 illustrates an example optical system 600 in which a lens 610 optically couples light emitters 612, 614, 616, and 618 to optical waveguides 620, 622, 624, and 626, respectively. Optical system 600 could be a component of a lidar device, such as lidar device 500 shown in FIG. 5. In this example, lens 610 has a modified cylindrical shape with a long axis 630 and a plurality of surfaces surrounding the long axis 630. The plurality of surfaces are exemplified in FIG. 6 by a surface 632 facing the light emitters 612-618 and a surface 634 facing the optical waveguides 620-626. In addition, the plurality of surfaces may include one or more flat surfaces (not shown) between surface 632 and surface 634. In example embodiments, the surface 632 is a convex surface, and the surface 634 is either a flat surface or another convex surface. However, lens 610 could have other shapes as well.

As shown, surface 632 is spaced apart from light emitters 612-618 by an air gap, and surface 634 is spaced apart from optical waveguides 620-626 by an air gap. With this configuration, surface 632 may include an AR coating that reduces reflections of the light emitted by light emitters 612-618. In some embodiments, the AR coating reduces reflections to less than 1%. In some embodiments, the AR coating reduces reflection to less than 0.1%. The surface 634 may also include an AR coating. Alternatively, the surface 634 could be bonded to the optical waveguides 620-626 by an optical coupling adhesive.

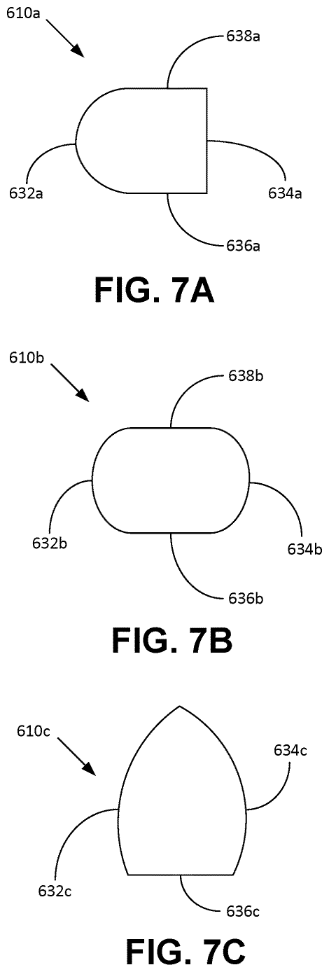

FIGS. 7A-7C illustrate possible cross-sectional shapes of lens 610 (e.g., a cross section of lens 610 in a plane perpendicular to the long axis 630) in accordance with example embodiments. It is to be understood, however, that other cross-sectional shapes of lens 610 are possible as well.

FIG. 7A illustrates a cross-sectional shape 610a of lens 610 that includes a convex surface 632a, a flat surface 634a opposite the convex surface 632a, and flat surfaces 636a and 638a between the surfaces 632a and 634a. The flat surface 634a may be generally perpendicular to the flat surfaces 636a and 638a. Thus, FIG. 7A illustrates a lens 610 that has a D-shaped cross section. The flat surface 636a may serve as a mounting surface for mounting the lens 610 on a substrate (e.g., substrate 564) in an orientation such that the convex surface 632a faces the light emitters 612-618 and the flat surface 634a faces the optical waveguides 620-626. In this orientation, light emitted by the light emitters 612-618 enters the lens 610 through the convex surface 632a and exits the lens 610 through the flat surface 634a. An AR coating may be applied to at least a portion of the convex surface 632a. Alternatively or additionally, an AR coating may be applied to at least a portion of the flat surface 634a.

FIG. 7B illustrates a cross-sectional shape 610b of lens 610 that includes a convex surface 632b, a convex surface 634b opposite the convex surface 632b, and flat surfaces 636b and 638b between the surfaces 632b and 634b. Thus, FIG. 7B illustrates a lens 610 that has a double-convex shape with two flat surfaces. The flat surface 636b may serve as a mounting surface for mounting the lens 610 on a substrate (e.g., substrate 564) in an orientation such that the convex surface 632b faces the light emitters 612-618 and the convex surface 634b faces the optical waveguides 620-626. In this orientation, light emitted by the light emitters 612-618 enters the lens 610 through the convex surface 632b and exits the lens 610 through the convex surface 634b. An AR coating may be applied to at least a portion of the convex surface 632b. Alternatively or additionally, an AR coating may be applied to at least a portion of the convex surface 634b.

FIG. 7C illustrates a cross-sectional shape 610c of lens 610 that includes a convex surface 632c, a convex surface 634c, and a flat surface 636c. Thus, FIG. 7C illustrates a lens 610 that has a double-convex shape with one flat surface. The flat surface 636c may serve as a mounting surface for mounting the lens 610 on a substrate (e.g., substrate 564) in an orientation such that the convex surface 632c faces the light emitters 612-618 and the convex surface 634c faces the optical waveguides 620-626. In this orientation, light emitted by the light emitters 612-618 enters the lens 610 through the convex surface 632c and exits the lens 610 through the convex surface 634c. An AR coating may be applied to at least a portion of the convex surface 632c. Alternatively or additionally, an AR coating may be applied to at least a portion of the convex surface 634c.

With the cross-sectional shape 610a illustrated in FIG. 7A, lens 610 has a full width defined by a greatest distance between the convex surface 632a and the flat surface 634a. Similarly, the cross-sectional shape 610b illustrated in FIG. 7B has a full width defined by a greatest distance between the convex surface 632b and the convex surface 634b, and the cross-sectional shape 610c illustrated in FIG. 7C has a full width defined by a greatest distance between the convex surface 632c and the convex surface 634c. In some examples, the full width of lens 610 could be less than 1 millimeter, less than 500 microns, or less than 150 microns. The length of the lens 610 along the long axis 630, however, could be much greater than the full width of the lens 600. In some examples, the length of the lens 610 could be more than ten times the full width of lens 610. In some examples, the length of the lens 610 could be more than one hundred times the full width of lens 610. Other examples are possible as well.

In order for the flat surfaces 636a, 636b, and 636c illustrated in FIGS. 7A-7C to serve as a reliable mounting surface for the lens 600, it is beneficial for the flat surface to have a width in a direction perpendicular to the long axis 630 that is at least half the full width of the lens 610.

In some implementations, lens 610 is composed of an optical glass, such as BK7. In some implementations, optical waveguides 620-626 are composed of a polymeric material. For example, optical waveguides 620-626 could be composed of a photoresist material, such as SU-8.

In some implementations, light emitters 612-618 are laser diodes 612-618. Each of laser diodes 612-618 may emit light that has a first divergence along a fast axis and a second divergence along a slow axis that is perpendicular to the fast axis, with the first divergence being greater than the second divergence. This divergence is illustrated in FIG. 6 as emitted light 642-648 diverging from laser diodes 612-618, respectively. In such implementations, lens 610 may function as a FAC lens that at least partially collimates the emitted light 642-648 along the respective fast axis of each laser diode 612-618. In the example shown in FIG. 6, each of laser diodes 612-618 has a fast axis that is perpendicular to the plane of the page and perpendicular to the long axis 630 of lens 610, and each of laser diodes 612-618 has a slow axis that is in the plane of the page and parallel to the long axis 630 of lens 610. Thus, lens 610 acting as a FAC lens may reduce the divergence of emitted light 642-648 along the fast axis of each of laser diodes 612-618 (e.g., without substantially affecting the divergence of emitted light 642-648 along the slow axis of each of laser diodes 612-618) so as to provide partially-collimated light.

FIGS. 7A-7C illustrate various shapes that are possible for the lens 610 in optical system 600, as described above. It is to be understood that other variations to the optical system 600 shown in FIG. 6 are possible as well. For example, while FIG. 6 illustrates an example in which lens 610 optically couples four light emitters to four optical waveguides, lens 610 could optically couple a greater or fewer number of light emitters to a greater or fewer number of optical waveguides. In addition, while FIG. 6 shows an air gap between surface 634 of lens 610 and the optical waveguides 620-626, the surface 634 could instead be bonded to the optical waveguides 620-626 (e.g., using an optical coupling adhesive).

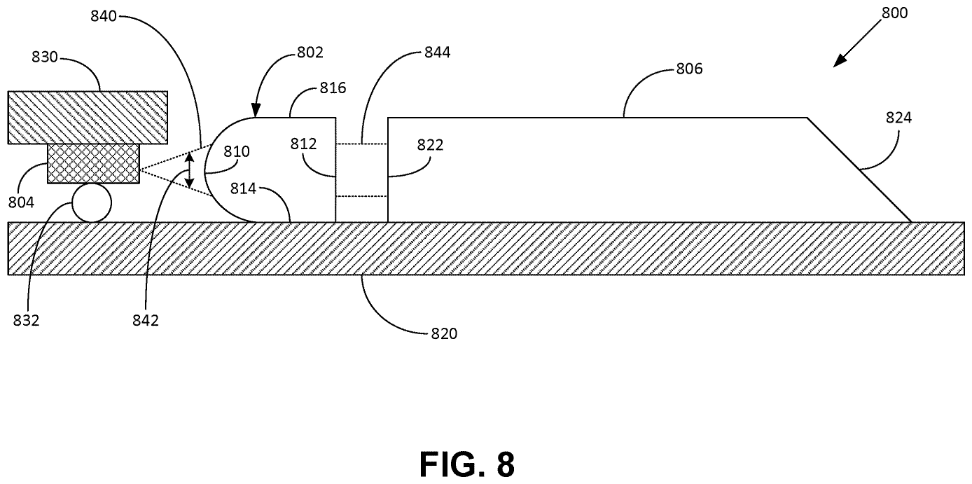

FIG. 8 illustrates an example optical system 800 in which a FAC lens 802 optically couples a laser diode 804 with an optical waveguide 806. FIG. 8 may represent a more detailed view of a portion of the optical system 600 illustrated in FIG. 6. Additionally, optical system 800 could be a component of a lidar device, such as lidar device 500 shown in FIG. 5.

As shown, the FAC lens 802 has a modified cylindrical shape similar to lens 610, with a long axis and a plurality of surfaces surrounding the long axis. In this example, the plurality of surfaces include an input surface 810 that is convex, an output surface 812 that is flat, and flat surfaces 814 and 816 between the convex input surface 810 and the flat output surface 812. Thus, FAC lens 802 has a D-shaped cross section, for example, as shown in FIG. 7A. The convex input surface 810 faces the laser diode 804, and the flat output surface 812 faces the optical waveguide 816.

In the example optical system 800 illustrated in FIG. 8, the FAC lens 802 and the optical waveguide 806 are mounted on a substrate 820. The substrate 820 could be similar to the substrate 564 illustrated in FIG. 5. For example, the substrate 820 could be composed of glass or other material that is transparent to the wavelengths of light emitted by the laser diode 804. The optical waveguide 806 could be similar to the optical waveguides 550 and 552 illustrated in FIG. 5. Thus, optical waveguide 806 can include an input end 822 and an output end 824 that includes a reflective surface. The optical waveguide 806 can be configured to guide light from the input end 822 to the output end 824, and the reflective surface reflects at least a portion of the guided light out of the waveguide 806 and through the substrate 820.

The flat surface 814 of FAC lens 802 could serve as a mounting surface for mounting the FAC lens 802 on substrate 820 in an orientation with convex input surface 810 facing laser diode 804 and flat output surface 810 facing optical waveguide 806. In some examples, the flat surface 814 of FAC lens 802 could be bonded to the substrate 820 using an adhesive, such as a UV-curable adhesive. In some examples, the optical waveguide 806 could be a photoresist material that is photolithographically patterned on substrate 820.

In the example shown in FIG. 8, the laser diode 804 is mounted to a printed circuit board (PCB) 830. In addition, the laser diode 804 is positioned over the substrate 820 by a spacer 832 so as to be aligned with FAC lens 802. The spacer 832 could be an optical fiber or other structure that is mounted on substrate 820 and that is in physical contact with laser diode 804. It is to be understood, however, that the laser diode 804 could be positioned in other ways such that the laser diode 804 is aligned with the FAC lens 802.

With the laser diode 804 aligned with FAC lens 802, the laser diode 804 emits emitted light 840 that enters the FAC lens 802 through the convex input surface 810. In this example, the emitted light 840 diverges along a fast axis 842 that is in the plane of FIG. 8. The FAC lens 802 reduces the divergence of the emitted light 840 along the fast axis 842 so as to at least partially collimate the light along the fast axis 842. The partially collimated light 844 exits the FAC lens 802 through the flat output surface 812 and enters the optical waveguide 806 through the input end 822.

In the example optical system 800 illustrated in FIG. 8, the convex input surface 810 of the FAC lens 802 is separated from the laser diode 804 by an air gap. With this configuration, some of the emitted light 840 may be reflected off the convex input surface 810 of FAC lens 802 and go back into the laser diode 804, which may cause instabilities in the light output by the laser diode 804. To reduce such reflections, an AR coating may be applied to the convex input surface 810. In addition, the flat output surface 812 is separated from the input end 822 of the optical waveguide 806 by an air gap, which results in reflections that reduce the output throughput. To reduce such reflections, an AR coating may also be applied to the flat output surface 812 of the FAC lens 802 and/or to the input end 822 of the optical waveguide 806.

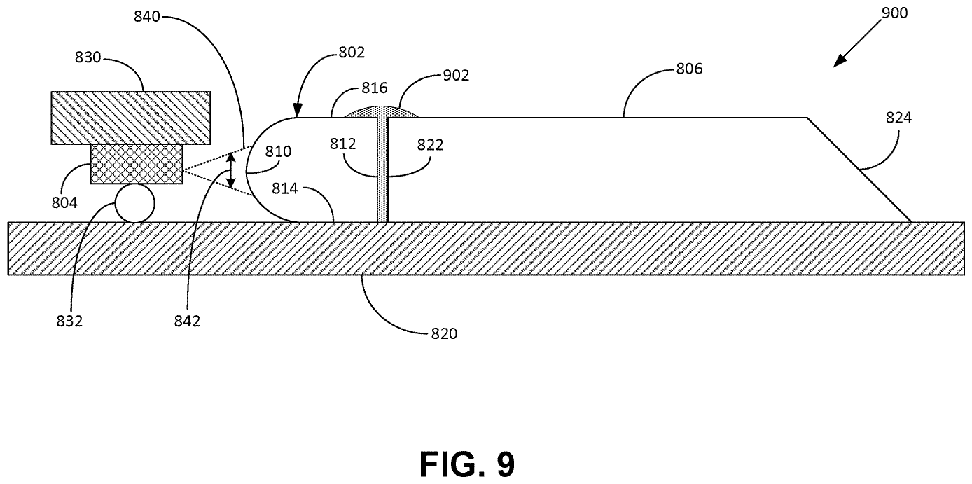

FIG. 9 illustrates an example optical system 900 that is similar to optical system 800, except that there is no air gap between the flat output surface 812 of FAC lens 802 and the input end 822 of optical waveguide 806. Instead of an air gap, the flat output surface 812 of FAC lens 802 is bonded to the input end 822 of optical waveguide 806 by an optical coupling adhesive 902. The optical coupling adhesive 902 can have an index of refraction that reduces reflections between the flat output surface 812 of FAC lens 802 and the input end 822 of optical waveguide 806, such that no AR coating is applied to either the flat output surface 812 or the input end 822. However, the convex input surface 810 of FAC 802 may still include an AR coating.

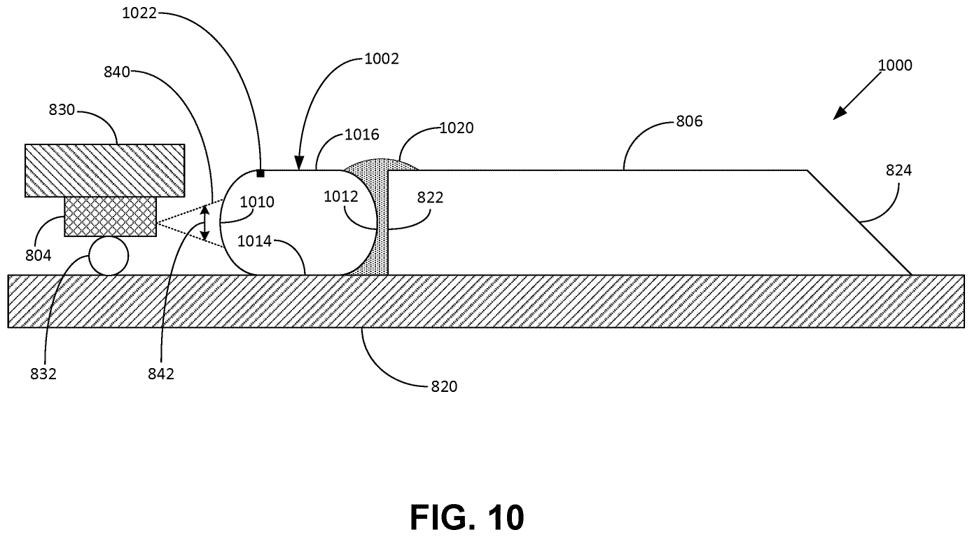

FIG. 10 illustrates an example optical system 1000 that is similar to the optical system 900, except that it includes a FAC lens 1002 with a double-convex shape (e.g., as shown in FIG. 7B). As shown, FAC lens 1002 has a convex input surface 1010, a convex output surface 1012, and flat surfaces 1014 and 1016 between the input surface 1010 and the output surface 1012. There is an air gap between the convex input surface 1010 and the laser diode 804. To reduce reflections, the convex input surface 1010 has an AR coating. However, there is no air gap between the convex output surface 1012 and the input end 822 of optical waveguide 806 because the space is filled in with an optical coupling adhesive 1020. The optical coupling adhesive 1020 may have an index of refraction that is lower than the index of refraction of the FAC lens 1002 (e.g., to retain some of the optical power of the FAC lens 1002). As a result, the convex output surface 1012 and the input end 822 may not have an AR coating.

In the example shown in FIG. 10, FAC lens 1002 also includes a side identification marker 1022 in a portion of the flat surface 1016 that is located closer to the input surface 1010 than the output surface 1012. The side identification marker 1022 can be a notch, frosted area, chamfer, or any other type of marking that can identify convex input surface 1010 as the convex surface that has an AR coating and that should be positioned toward the laser diode 804 and away from the optical waveguide 806. In this way, the side identification marker 1022 can help with proper assembly of the components on substrate 820 and with inspection after assembly.

Although FIG. 10 shows the side identification marker 1022 located in flat surface 1016 closer to input surface 1010, the marker 1022 could be otherwise located in FAC lens 1002. Other variations are possible as well. For example, the FAC lens 1002 could be spaced apart from the optical waveguide 806 by an air gap instead of bonded to the optical waveguide 806 by optical coupling adhesive. In that case, the convex input surface 1010 and the convex output surface 1012 could each have an AR coating. In that approach, the FAC lens 1002 may also include a side identification marker 1022. However, proper assembly may allow for either convex surface to face the laser diode.

In the examples illustrated in FIGS. 8, 9, and 10, the surface that mounts the FAC lens to the substrate 820 is described as being flat (flat surface 814 shown in FIGS. 8 and 9, flat surface 1014 shown in FIG. 10). However, the mounting surface of the FAC lens need not be perfectly flat. For example, the mounting surface of the FAC lens could be slightly concave such that the FAC lens is supported on the substrate at two points. With reference to FIG. 10, the mounting surface 1014 of FAC lens 1002 could be slightly concave so that FAC lens 1002 is supported on the substrate 820 at a first point (e.g., a point where the mounting surface 1014 intersects the input surface 1010) and at a second point (e.g., a point where the mounting surface 1014 intersects the output surface 1012). The mounting surface of the FAC lens could have other shapes (e.g., other non-convex shapes) as well.

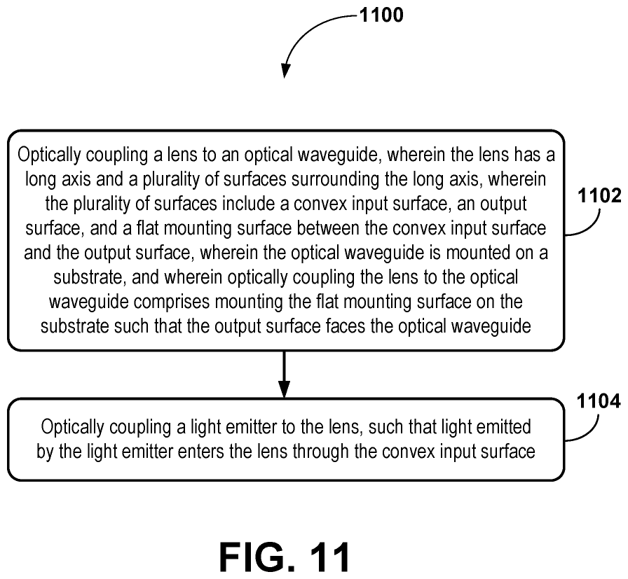

FIG. 11 is a flowchart diagram of a method 1100, according to example embodiments. In some embodiments, method 1100 may be used to fabricate an optical system, such as optical system 600 shown in FIG. 6, optical system 800 shown in FIG. 8, optical system 900 shown in FIG. 9, or optical system 1000 shown in FIG. 10. Further, an optical system fabricated in accordance with method 1100 could be a component of a lidar device, such as lidar device 500 shown in FIG. 5.

At block 1102, the method 1100 may include optically coupling a lens to an optical waveguide, wherein the lens has a long axis and a plurality of surfaces surrounding the long axis, wherein the plurality of surfaces include a convex input surface, an output surface, and a flat mounting surface between the convex input surface and the output surface, wherein the optical waveguide is mounted on a substrate, and wherein optically coupling the lens to the optical waveguide comprises mounting the flat mounting surface on the substrate such that the output surface faces the optical waveguide.

At block 1104, the method 1100 may include optically coupling a light emitter to the lens, such that light emitted by the light emitter enters the lens through the convex input surface.

In method 1100, the flat mounting surface may beneficially serve to position the lens on the substrate in a desired orientation with the convex surface facing the light emitter and the output surface facing the optical waveguide. The mounting can be performed in a pick-and-place operation, and a machine vision system may be used to confirm that the lens is in the desired orientation on the substrate. The lens may also include a marker (e.g., such as side identification marker 1022), to help determine the desired orientation of the lens as it is being mounted on the substrate.

In some embodiments, the lens is bonded to substrate using an adhesive (e.g., a UV-curable adhesive) after the lens has been mounted on the substrate in the desired orientation. For example, adhesive may be dispensed to bond the flat mounting surface of the lens to the substrate, after the lens has been placed on the substrate and a machine vision system has verified that the lens is in the desired orientation.

In some embodiments, the output surface is a flat surface. Thus, the lens could have a D-shaped cross section, for example, as shown in FIG. 7A. In other embodiments, the output surface is a convex surface. Thus, the lens could have a double-convex cross section, for example, as shown in FIG. 7B or as shown in FIG. 7C.

In some embodiments, the method 1100 further includes applying an AR coating to the convex input surface of the lens. In some embodiments, the method 1100 further includes applying an AR coating to the output surface of the lens. In some embodiments, the AR coating is applied to the convex input surface and/or the output surface before the lens is mounted on the substrate. The AR coating may be applied to the convex input surface and/or the output surface by directing a coating material (e.g., using evaporation or sputtering) in a single direction toward the lens. A flat surface of the lens (e.g., the flat surface used to mount the lens to the substrate) may be used to align the lens during the AR coating process. In this way, the AR coating may cover only a portion of the lens.

In some embodiments, method 1100 further includes bonding the output surface of the lens to the optical waveguide using an optical coupling adhesive. In some implementations, the optical coupling adhesive is sufficient to reduce reflections between the output surface of the lens and the optical waveguide without an AR coating on the output surface. For example, the optical coupling adhesive may reduce reflections to about 1% or less.

In some embodiments, method 1100 further includes forming the lens. The lens could be formed, for example, by thermal drawing a preform through a mold that provides a desired cross-sectional shape, such as a D-shape as shown in FIG. 7A or a double-convex shape as shown in FIG. 7B or 7C.

In some embodiments, method 1100 further includes forming the optical waveguide on the substrate. For example, the optical waveguide could be formed on the substrate by photolithographically patterning a photoresist material disposed on the substrate.

In some embodiments, optically coupling the light emitter to the lens involves positioning the light emitter over the substrate by means of a spacer. The spacer can be mounted on the substrate and can physically contact the light emitter so that an optical axis of the light emitter is aligned with an optical axis of the lens.

In some embodiments, the light emitter is a laser diode that emits light that diverges along a fast axis and diverges less rapidly along a slow axis. In such embodiments, the lens may serve as a fast-axis collimator that at least partially collimates the light emitted by the laser diode.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. An optical system, comprising:
a light emitter;
an optical waveguide; and
a lens that optically couples the light emitter to the optical waveguide, wherein the lens has a long axis and a plurality of surfaces surrounding the long axis, wherein the plurality of surfaces includes a first convex surface, a second convex surface opposite the first convex surface, and a flat surface between the first and second convex surfaces, wherein the first convex surface faces the light emitter such that light emitted by the light emitter enters the lens through the convex surface, and wherein at least some of the light emitted by the light emitter that enters the lens through the first convex surface exits the lens through the second convex surface.

2. The optical system of claim 1, wherein the light emitter comprises a laser diode, wherein the laser diode emits light that has a first divergence in a first direction and a second divergence in a second direction, wherein the first divergence is greater than the second divergence, and wherein the lens at least partially collimates the emitted light in the first direction so as to reduce the divergence in the first direction.

3. The optical system of claim 2 wherein the first direction corresponds to a fast axis of the laser diode and the second direction corresponds to a slow axis of the laser diode.

4. The optical system of claim 1, wherein the first convex surface of the lens is spaced apart from the light emitter by an air gap.

5. The optical system of claim 1, wherein the lens has an anti-reflection coating on the first convex surface.

6. The optical system of claim 5, wherein the anti-reflection coating reduces reflections of the light emitted by the light emitter to less than 1%.

7. The optical system of claim 5, wherein the anti-reflection coating reduces reflections of the light emitted by the light emitter to less than 0.1%.

8. The optical system of claim 1, wherein the lens has an anti-reflection coating on the second convex surface.

9. The optical system of claim 1, wherein the lens has a first anti-reflection coating on the first convex surface and a second anti-reflection coating on the second convex surface.

10. The optical system of claim 1, further comprising:
a substrate, wherein the optical waveguide and the flat surface of the lens are disposed on the substrate.

11. The optical system of claim 10, wherein the flat surface of the lens is bonded to the substrate by an adhesive.

12. The optical system of claim 10, wherein the substrate comprises a material that is transparent to the light emitted by the light emitter.

13. The optical system of claim 1, wherein the flat surface is a first flat surface, and wherein the plurality of surfaces includes a second flat surface opposite the first flat surface.

14. The optical system of claim 13, wherein the lens further comprises a side identification marker in a portion of the second flat surface that is located closer to the first convex surface than the second convex surface.

15. The optical system of claim 14, wherein the side identification marker comprises a notch, a frosted area, a chamfer, or other type of marking.

16. The optical system of claim 1, wherein the second convex surface is surface is spaced apart from the optical waveguide by an air gap.

17. The optical system of claim 1, wherein the second convex surface is bonded to the optical waveguide by an optical coupling adhesive.

18. The optical system of claim 17, wherein the optical coupling adhesive has an index of refraction that is lower than an index of refraction of the lens.

19. The optical system of claim 1, wherein the lens has a full width defined by a greatest distance between the first convex surface and the second convex surface, wherein the flat surface has a width in a direction perpendicular to the long axis, and wherein the width of the flat surface is at least half of the full width of the lens.

20. The optical system of claim 1, further comprising:
a plurality of light emitters that includes the light emitter; and
a plurality of optical waveguides that includes the optical waveguide, wherein the lens optically couples each light emitter of the plurality of light emitters to a respective optical waveguide of the plurality of optical waveguides.
